(19) United States
(12) Patent Application Publication
(10) Pub. No.: US 2005/0194464 A1
(43) Pub. Date: Sep. 8, 2005

(54) Adjustable sprinkler

(76) Inventor: Kenneth Bruninga, Mapleton, IL (US)

Correspondence Address: Bell, Boyd & Lloyd LLC, P.O. Box 1135, Chicago, IL, 60690-1135, US

(21) Appl. No.: 10/795,940

(22) Filed: Mar. 8, 2004

(51) Int. Cl. B05B 12/08

(52) U.S. Cl. 239/200; 239/63

(57) ABSTRACT

An adjustable sprinkler including an inner housing slideably engaged with an outer housing. The inner housing includes a head rotatably mounted to a body. The outer housing includes an inlet which receives pressurized water and transfers the pressurized water to a nozzle attached to the head. The inner housing includes a reverser for selectively driving an impeller in two different directions. The impeller is connected to a reducer which reduces the rotational rate transferred from the impeller to the head and also enables the head to be manually rotated without causing damage to the internal components of the adjustable sprinkler. The head includes a click set and a cap. The cap defines at least one opening to enable a user to insert a tool through the cap to adjust and set the boundaries of the spray pattern using the click set.

### BACKGROUND OF THE INVENTION

Several different types of known irrigation devices such as sprinklers are used to irrigate lawns, garden beds, landscaping, fields, crops and other similar areas. One type of known irrigation device is an oscillating sprinkler which is commonly used by homeowners to water their lawns, bushes, trees and gardens. Such oscillating sprinklers are manually placed in an area to be watered and manually connected to a hose or other pressurized water source. The pressurized water activates the sprinkler and causes the sprinkler to oscillate or move back and forth about a substantially horizontally disposed axis. Other types of sprinklers that emit water in different spray patterns such as circular spray patterns are also known. Generally, however, these types of sprinklers must be manually placed in the desired watering location or locations by a user to water the desired irrigation areas. Therefore, oscillating sprinklers and other similar above-ground sprinklers require users to spend time placing and adjusting the sprinklers in different locations to water those locations.

Another type of known irrigation device is an in-ground or pop-up type sprinkler which is generally utilized as part of a larger sprinkler system. These sprinklers are commonly used at residences such as homes and for commercial purposes such as near buildings, at golf courses or at farms where regular watering is required or desired.

One type of pop-up sprinkler is a stationary continuous stream sprinkler which projects a continuous stream of water to a specific area. Another type of pop-up sprinkler is an adjustable sprinkler which can be set to emit water in user determined different arc spray patterns. For example, an adjustable sprinkler can be set by a user to water a 90 degree spray pattern such as the corner of a garden. The adjustable sprinkler may also be set to water a 180 degree, 270 degree, 360 degree or any other suitable spray pattern. These in-ground pop-up adjustable sprinklers enable users to change and set the arc spray pattern of the sprinklers to water different segments or sections of the irrigation areas. Sprinkler systems usually employ numerous identical in-ground pop-up adjustable sprinklers in designated locations to fully cover an area such as a large lawn. These adjustable sprinklers are usually each set to a different or individual arc spray or water spray pattern.

An example of an in-ground pop-up adjustable sprinkler is disclosed in U.S. Pat. No. 4,892,252 which is assigned to L. R. Nelson Corporation (“the '252 paten”), the assignee of the present application. The '252 patent describes an adjustable part circle sprinkler assembly which includes a sprinkler head structure rotatably connected to a sprinkler body structure which form a turret that slides into and out of an outer housing attachable to a pressurizable water pipe. The sprinkler receives pressurized water at an inlet and delivers the pressurized water to a nozzle in the head structure which emits the water to a designated irrigation area.

To install a sprinkler system using the adjustable sprinklers disclosed in the '252 patent, each adjustable sprinkler is attached to a water pipe. Initially, the sprinklers are set to rotate in a continuous 360 degree spray pattern. If a part circle or less than 360 degree spray pattern is desired, the adjustable sprinkler is rotated about the connection to the water pipe to direct a nozzle at the middle or center of the designated irrigation area. The installer then must remove each cap to access the spray pattern control assembly positioned inside the head structure of each sprinkler. The installer then removes and flips over the spray pattern control assembly and re-engages the spray pattern control assembly inside the head structure. The installer manually rotates and positions the adjustable or adjustment members of the spray pattern controller to set the boundaries of the designated spray pattern for each sprinkler. For example, the adjustment members can be positioned opposite each other on the same axis to set a 180 degree arc spray or water spray pattern. After the adjustment members are set in position for each sprinkler of the sprinkler system, the installer must verify the boundaries set by the adjustment members by manually rotating the head structure. This is a fairly time consuming process during the installment process and during servicing as further discussed below.

More specifically, the adjustable sprinkler described in the '252 patent includes a slip clutch mechanism which includes a plurality of teeth that engage and co-act with a plurality of corresponding teeth formed on the interior surface of the body structure. The slip clutch mechanism enables a user such as the installer to manually turn the head structure in a click-like or segmented manner to verify the boundaries set by the adjustment members. After the user verifies the boundaries of the arc spray pattern by rotating the head structure and tripping the boundaries, the user replaces and secures the cap to the top of the sprinkler head structure. The sprinkler head structure rotates and emits water based on the spray pattern set by the user using these adjustment members. The user must repeat this process for each adjustable sprinkler connected to the water pipes in the sprinkler system. After all of the spray patterns are set for each of the different adjustable sprinklers, the user opens a valve or other control to cause the pressurized water from the water pipe to flow to each of the adjustable sprinklers. The user then inspects each adjustable sprinkler to make sure that the correct spray pattern is set for those sprinklers and makes any further adjustments to the spray patterns as necessary. Alternatively, a timer may be connected in line with the water pipe to control the operation of the valve or other control connected to the water pipe. The timer causes the valve or control to open at specific times or on periodic basis based on programmed times stored in the timer.

One problem with such adjustable sprinklers is that a user such as an installer or person servicing the system must spend a significant amount of time removing the caps from the head structures of the individual sprinklers and then setting the desired arc spray patterns for each of those sprinklers. Time is also required to verify the boundaries set by the user for each of the adjustable sprinklers. A significant amount of time and effort is thus required in the field to set up or adjust one or more adjustable sprinklers in a sprinkler system. If one or more of the sprinklers malfunction or the spray pattern is not set properly, a user must go back to each of those sprinklers and remove the caps to modify the spray pattern to be the desired spray pattern.

Another problem with such adjustable sprinklers is that when a user verifies the boundaries of the spray pattern, the slip clutch mechanism is rotated so that the teeth are moved along the grooves on the interior surface of the head structure. This movement makes a “clicking” or “ratcheting” sound as the sprinkler head structure is rotated. As a result, a user has significant difficulty determining if the adjustment members are tripped. Manually rotating the sprinkler head structure past the adjustment members can cause the memory clutch to activate or engage. In such case, the user has to wait until the sprinkler head structure rotates back within the preset spray pattern until the sprinkler head structure can be manually turned again. To overcome this problem, users have to manually turn the sprinkler head structure to a point just prior to the position of the adjustable member and then let the sprinkler head structure automatically rotate and trip the boundary. This process must be repeated each time a user wants to verify each boundary of the spray pattern for each such adjustable sprinkler in the sprinkler system. A significant amount of time and energy can thus be spent in the field adjusting and verifying the different spray patterns of each of the different adjustable sprinklers. Because some sprinkler systems include several different sprinklers, the amount of time spent adjusting the sprinklers can be significant.

Accordingly, there is a need for adjustable sprinklers which are easy to install and more easily enable users to set the spray pattern for each of the sprinklers efficiently in the field which saves significant time and costs associated with the installation and servicing of the adjustable sprinklers.

### SUMMARY OF THE INVENTION

One embodiment of the present invention is directed to an adjustable sprinkler and more specifically, to a pop-up adjustable sprinkler including an adjustable spray pattern controller and a slip clutch which co-act to enable a user to adjust the water spray pattern of the adjustable sprinkler without removing the cap of the sprinkler and which also enable a user to quickly and easily verify the boundaries of the water spray pattern by manually rotating the head of the adjustable sprinkler. One embodiment of the present invention also enables a user to manually turn the sprinkler without activating or engaging the memory clutch.

In one embodiment, the adjustable sprinkler of the present invention includes an outer housing and an inner housing disposed within the outer housing. The outer housing defines an inlet and is removably connectable to a pressurized water source. The inner housing includes a head rotatably connected to a body. The inner housing and specifically, the body of the inner housing, is slideably engaged within the outer housing. When the pressurized water enters the outer body through the inlet, the force of the pressurized water causes the inner housing to move or slide upwardly to a fully extended or operative position. In the operative position, the pressurized water is directed to the head and is emitted from an outlet member attached to the head such as a suitable nozzle. The head rotates the nozzle between two boundaries of a designated spray pattern to irrigate an area such as a lawn, garden or crop.

In one embodiment, a reverser configured to receive the pressurized water from the outer housing is mounted in the body of the inner housing. The reverser is operable to direct the pressurized water to an impeller which causes the impeller to rotate in a clockwise or counter clockwise direction. The impeller is coupled to one end of a reducer. A rotary output member is rotatably connected to the opposite or other end of the reducer. In one embodiment, the reducer is operable to rotate the rotary output member in the same direction as the impeller and at a rate of rotation which is reduced or less than the rate of rotation of the impeller. In turn, the rotary output member is connected to the head. Therefore, the rotary output member, the slip clutch and the head rotate in the same direction and at the same reduced rate of rotation.

In one embodiment, the adjustable sprinkler includes a spray pattern control mechanism or spray pattern controller positioned inside the head attached to a shaft where the shaft is coupled to the reverser. The spray pattern controller includes a click set having a first adjustment member and a second adjustment member which represent the first and second boundaries of the desired spray pattern. A stop is attached to or extends from the inner wall of the head. As the head rotates, the stop rotates between the first and second adjustment members. When the stop contacts the first or second adjustment member, the spray pattern controller causes the reverser to reverse the rotational direction of the impeller and thereby reverse the rotational direction of rotation of the head. This process continues until the pressurized water is released from the sprinkler, which stops the rotation of the head and allows the retraction of the inner housing downward into the outer housing.

In one embodiment, the adjustable sprinkler of the present invention includes a cap which is fixedly attached to the top of the head. The cap defines at least one opening suitably sized to receive an adjuster such as an adjustment tool. The cap includes movable or flexible flaps extending into the opening to prevent dirt, sand or other particles from entering the cap when the adjuster is inserted into the opening and at other times. Initially, the click set is not engaged with the shaft. In the non-engaged position, the click set does not contact the stop during operation of the adjustable sprinkler to enable the head to rotate in a continuous 360 degree spray pattern. Alternatively, to set a spray pattern that is less than 360 degrees, the adjuster is inserted through the opening in the cap to push the click set downward to engage the click set with the top of the shaft. The first adjustment member is fixable in position during assembly. Therefore, the entire adjustable sprinkler is moved or rotated to align the first adjustment member with the first boundary of the desired spray pattern. To set the second boundary of the spray pattern, the adjuster is moved or rotated to move the position of the second adjustment member away from or toward the first adjustment member of the click set to set a desired spray pattern for the sprinkler. Any suitable spray pattern including a reversible 360 degree spray pattern may be set using the adjuster. The adjuster remains engaged with the click set while the boundary is being set to prevent the memory clutch from being activated or engaged. By setting and adjusting the spray pattern using a non-removable cap and an adjuster of the present invention, a user such as an installer saves significant time and energy in the field because the user does not have to spend the time and effort to remove each of the caps of the sprinklers that must be set or adjusted in a sprinkler system.

In one embodiment of the present invention, the reducer is operable to enable the head to rotate in unison with the rotary output member during operation of the sprinkler and rotate the head independently from the rotary output member when the head is manually rotated in either direction at a designated level of force. Specifically in this embodiment, the reducer includes a first section having a first diameter and a second section having a second diameter, wherein the second diameter is greater than the first diameter. The larger second section is sized to frictionally engage resistors attached to the inside surface of the body and hold the reducer stationary during the normal operation of the sprinkler. The frictional engagement between the second section of the reducer and the resistors also enables the reducer to rotate when the head is manually rotated in either direction. In this manner, the reducer prevents the internal components of the sprinkler such as the reverser from being damaged or broken during the manual rotation of the head. In addition, the frictional engagement between the reducer and the resistors enables a user to smoothly manually rotate the head to identify and verify the boundaries of the spray pattern set with the click set.

Thus, the operation of the reducer enables a user such as an installer to smoothly manually rotate the head to easily identify and verify the boundaries of a desired spray pattern during the set-up, adjustment or repair of the sprinkler in the field. Accordingly, the reducer of the present invention saves significant time in the field because the boundaries of the spray pattern can be identified and verified quickly.

In one alternative embodiment, the cap and the top of the head are configured to include meshing threads to enable the cap to be screwed onto and off of the top of the sprinkler head structure. This cap enables a user to access the interior of the top of the head to repair or replace the click set mechanism and other components in the top of the head.

In another alternative embodiment, the cap includes a clear or see-through portion having first and second concentric rings. The bottom of each ring (i.e., the bottom of the cap) includes a generally rectangular post, which each take the place of the adjustment members described above. A user uses a key or other suitable adjustment tool to remotely adjust the boundaries and specifically, the posts to set a desired spray pattern.

In another alternative embodiment, the adjustable sprinkler includes a clear or see-through cap where one of the boundaries of the spray pattern is fixable and remains stationary. In one such embodiment, the cap includes only one ring which is adjustable using the key described above. The ring includes a post which extends downwardly from the bottom surface of the ring and into the interior of the head. A user uses the key to engage the slots in the top surface of the ring as described above and rotates the ring to position the post to set the second boundary or adjustable boundary of the spray pattern.

In another alternative embodiment, the adjustable sprinkler includes a one-eighth turn on/off locking cap that covers and seals the top of the head. This cap is screwed onto or off of the top of the head by turning the cap one-eighth of a turn. Specifically, the cap includes an outer portion and an inner portion which has a bayonet style configuration. The bayonet style configuration of the inner portion includes extensions which are positioned and inserted into corresponding spaces between threaded sections formed on the top inside surface of the head. Once inserted a user turns the cap one-eighth of a turn until one of the cap removably locks on the head.

In one alternative embodiment, the click set is operable to set both a 360 degree spray pattern and/or a part circle spray pattern (i.e., less than 360 degree pattern) using only one side of the click set. In this embodiment, the click set is positioned on a shaft which is coupled with the reverser. The click set rests on top of bumps or protrusions formed at the top of the shaft. In this position, the click set provides a 360 degree spray pattern. To have a part circle pattern, a user simply presses down on the click set to frictionally engage the click set with the protrusions and thereby engage the click set with the shaft. A user then positions the adjustment members as described above to set the boundaries to form a desired spray pattern. The click set therefore does not require a user to have to flip the click set over to change from a 360 degree spray pattern to a part circle pattern.

In another alternative embodiment, the click set includes markings attached to the top of the click set to indicate the spray pattern set by the user. In one embodiment, the markings are dark lines such as black lines inscribed in and slightly protruding from the top surface of the click set. In another embodiment, the click set includes markings having numbers and lines to indicate specific spray patterns. Thus, the click set of this embodiment enables a user to quickly and easily set commonly used spray patterns.

In another alternative embodiment, an adjustment section is movably mounted in the cap and is biased upwardly by a spring or other resilient member. The adjustment section includes an adjustment arm connected to and downwardly extending from the bottom of the adjustment section. The adjustment arm is integrally formed with the adjustment section and is adapted to engage a corresponding slot on the top adjustment member of the click set. The adjustment section defines a slot adapted to receive a tool such as a screwdriver. The spring biases the adjustment section upwardly so that the adjustment section is flush with the cap. To change the position of the top adjustment member of the click set, a user inserts the tool into the slot and presses downwardly on the adjustment section and the spring. The user rotates the adjustment section until the arm engages the slot on the adjustment member of the click set. The user rotates the adjustment member until the adjustment member is aligned with the desired boundary of the spray pattern. When the adjustment member is in the desired position, the tool is removed from the slot and the adjustment section moves upwardly into position on the cap.

In a further alternative embodiment, the cap of the adjustable sprinkler defines a generally central opening adapted to receive a tool such as a screwdriver. In one embodiment, the cap includes flaps or covers which extend over the opening to prevent sand, dirt or other particles from entering the adjustable sprinkler. The click set includes an adjustment mechanism which is connected to the click set and more specifically, connected to one of the adjustment members of the click set. A user inserts the tool through the opening and into engagement with the slot on the adjustment member of the click set. The user then rotates the tool to change the position of the adjustment member. When the adjustment member is aligned with the desired boundary of the spray pattern, the user removes the tool from the cap.

In another alternative embodiment, the cap defines an opening adapted to receive an adjustment tool. The adjustment tool includes an arm for engaging a corresponding slot defined by the click set. A first boundary of a desired spray pattern is fixed or not movable and is set by rotating the entire adjustable sprinkler about the threads on the water pipe. The adjustment tool is inserted into the opening to engage the arm of the tool with the click set. The tool is turned or rotated to turn or rotate the adjustment member to set one of the boundaries of the spray pattern. When the boundary is set, the tool is removed from the cap.

Accordingly, the present invention saves significant time and effort in the field by making the process of setting the boundaries for the different spray patterns easier and quicker and also enables a user to quickly and easily verify those boundaries.

It is an advantage of the present invention to provide an adjustable sprinkler including a spray pattern controller and a slip clutch which enables users to quickly and efficiently set the boundaries of a desired spray pattern and verify those boundaries.

Another advantage of the present invention is to provide an adjustable sprinkler that eliminates the need to remove the cap to set or adjust the boundaries of the spray pattern.

Additional features and advantages of the present invention are described in, and will be apparent from, the following Detailed Description of the Invention and the Figures.

### BRIEF DESCRIPTION OF THE FIGURES

FIG. 1 is a perspective elevation view of one embodiment of the adjustable sprinkler of the present invention illustrating the adjustable sprinkler in an operative position.

FIG. 1A is a top view of the embodiment of FIG. 1.

FIG. 2 is an exploded perspective view of the embodiment of FIG. 1 illustrating the cap, the positioner, the inner housing and the outer housing of the adjustable sprinkler.

FIG. 3 is an exploded perspective view of the positioner of the embodiment of FIG. 1.

FIG. 4 is an exploded perspective view of the inner housing illustrating certain of the components attached to the inner housing of the embodiment of FIG. 1.

FIG. 5 is a cross section of the embodiment of FIG. 1 taken substantially along line 5-5 of FIG. 1A.

FIG. 6 is a partial exploded perspective view of the embodiment of FIG. 1 illustrating the components used to adjust the boundaries of a desired spray pattern.

FIG. 7 is a partial perspective view of the embodiment of FIG. 1 illustrating the functional relationship between the spray pattern controller, the reducer and the reverser, wherein the components between the spray pattern controller and the reducer are removed.

FIG. 8 is an exploded perspective view of the reducer of the embodiment of FIG. 1.

FIG. 9 is an exploded perspective view of the reverser, the impeller and the bottom of the reducer of the embodiment of FIG. 1 illustrating the assembly of these components.

FIGS. 10A and 10B are partial perspective views of the embodiment of FIG. 1 illustrating the relationship between the function of certain components in the inner housing and the rotation of the head, wherein the reducer and other components between the spray pattern controller and the impeller are removed.

FIG. 11 is an exploded perspective view of one embodiment of the click set of the present invention.

FIG. 12 is a cut-away perspective view of an alternative embodiment of the cap.

FIG. 13A is a top view illustrating another alternative embodiment of the cap.

FIG. 13B is a bottom view of the alternative embodiment of the cap of FIG. 13A.

FIG. 13C is a diagrammatic view of one embodiment of the key used to adjust the spray pattern boundaries of the alternative embodiment of the cap of FIGS. 13A and 13B.

FIG. 14A is an enlarged partial side view of a further alternative embodiment of the present invention illustrating a cap including a bayonet-style configuration.

FIG. 14B is an enlarged top view of the head of the alternative embodiment of FIG. 14A.

FIG. 14C is an enlarged fragmentary perspective view of the locking component of the alternative embodiment of FIG. 14A.

FIG. 15 is an exploded perspective view of another alternative embodiment of the present invention illustrating a depressible spray pattern controller.

FIG. 16 is an exploded perspective view of a further embodiment of the present invention illustrating a cap including a slot adapted to receive a tool to engage the spray pattern controller.

FIG. 17 is an exploded perspective view of another alternative embodiment of the present invention illustrating a cap adapted to receive a key for adjusting the spray pattern of the adjustable sprinkler.

### DETAILED DESCRIPTION OF THE INVENTION

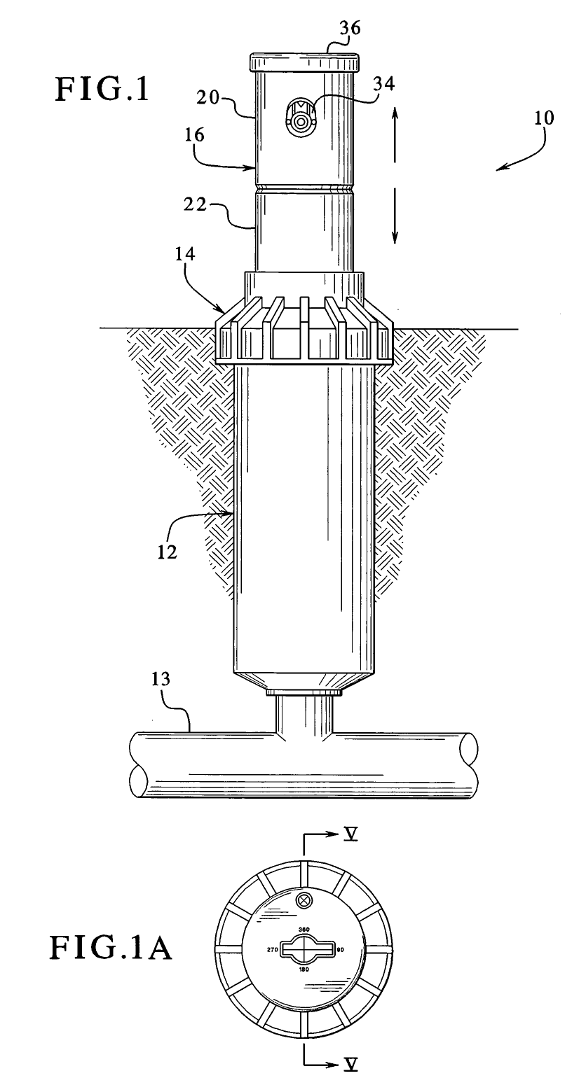

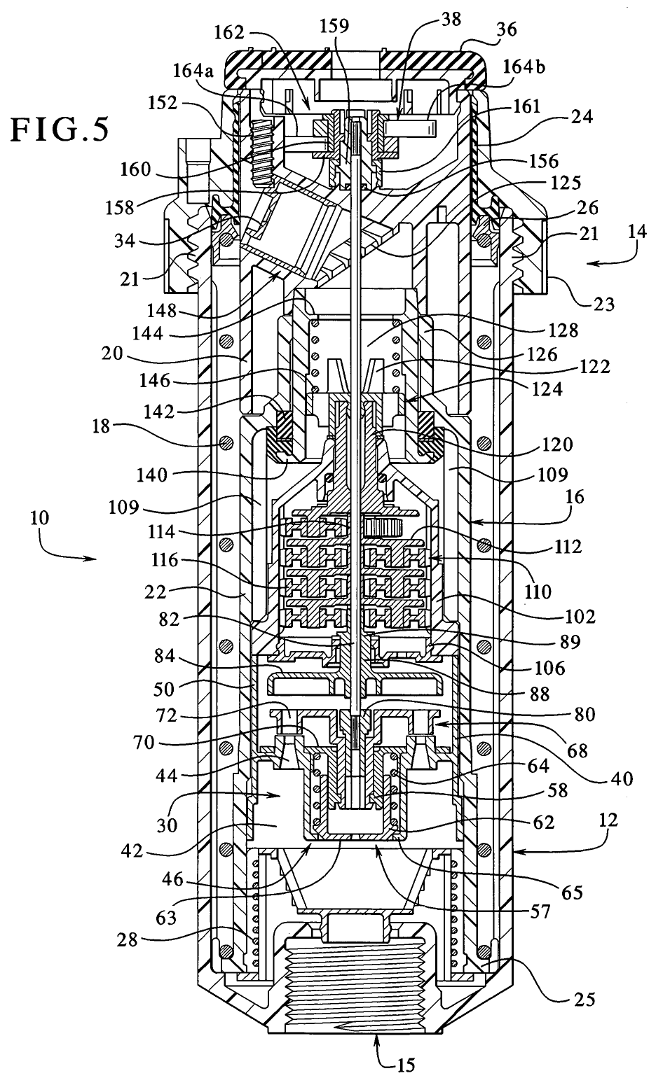

Referring now to the drawings and specifically to FIGS. 1 and 1A, one embodiment of the adjustable sprinkler, indicated by numeral 10, is generally illustrated. The in-ground or pop-up type adjustable sprinkler 10 includes an outer housing 12 suitably connectable to a pressurized water pipe 13, a positioner 14 which is threadingly engaged to the top of the outer housing 12 and an inner housing or turret 16 which is slideably mounted in the outer housing 12 and which extends through the positioner 14. The outer housing 12 defines a water inlet 15 (see FIG. 5) which is adapted to receive pressurized water from the pipe 13. As the pressurized water enters the outer housing through the water inlet 15, the pressure of the water pushes upwardly against the inner housing to cause the inner housing to move upwardly through the positioner 14 to a fully extended or operative position. In this position, the pressurized water is directed upwardly through the inner housing and to a suitable nozzle 34 which is removably connected to the inner housing 16. The nozzle 34 directs the pressurized water to a desired irrigation area or areas. When the irrigation of the desired area is complete, the pressurized water is drained or otherwise removed from the adjustable sprinkler which causes the inner housing 16 to slide downwardly through the positioner 14 and into the outer housing 12 to a non-extended or storage position. The non-extended position protects the inner housing 16 from damage when not in use and allows for mowing of lawns having such sprinkler systems.

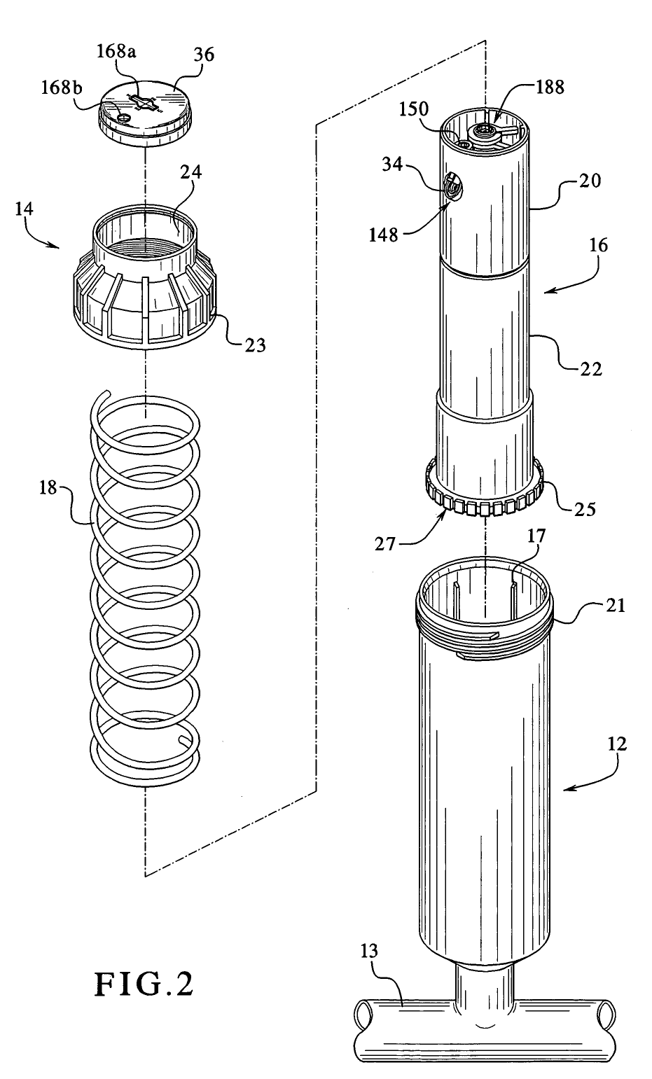

Referring now to FIG. 2, the outer housing 12 is shown connected to the pressurized water pipe 13 as described above. The outer housing 12 receives the pressurized water from the pipe 13 and also acts as a guide for the inner housing 16 which moves or slides upwardly and downwardly within the outer housing (i.e., along the longitudinal axis of the outer housing). In the illustrated embodiment, the outer housing 12 is generally tubular or cylindrically-shaped and defines a receptacle for receiving the inner housing or turret 16. The outer housing 12 includes an upper portion which is generally the same diameter and a lower beveled portion. The lower beveled portion includes a wall which defines the water inlet 15 and has a plurality of threads. The threads are integrally formed on the wall and enable the outer housing to threadingly engage corresponding threads formed on the pipe 13. Additionally, the inside surface of the outer housing 12 includes a plurality of longitudinal guides or fins 17 formed on the inside surface of the outer housing to engage the corresponding grooves 27 of the inner housing to prevent the body 22 of the inner housing 16 from rotating in either direction during the operation of the sprinkler as further discussed below.

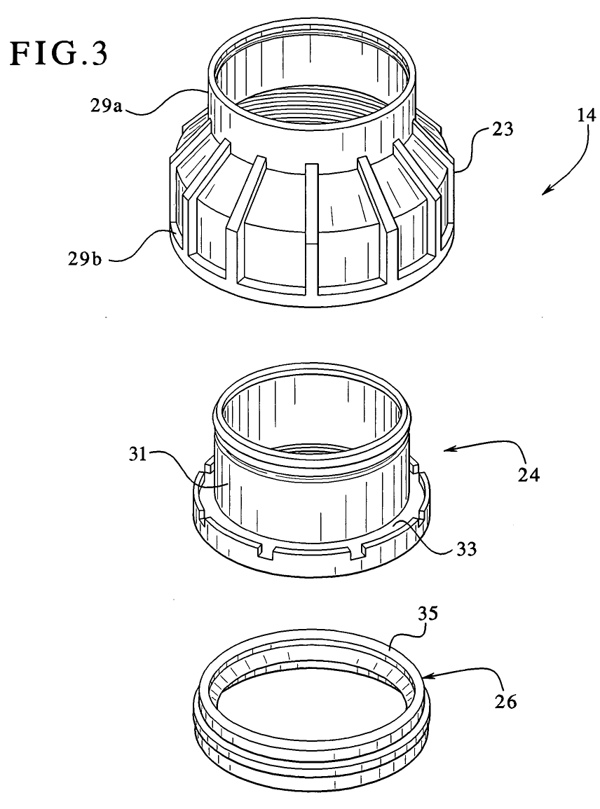

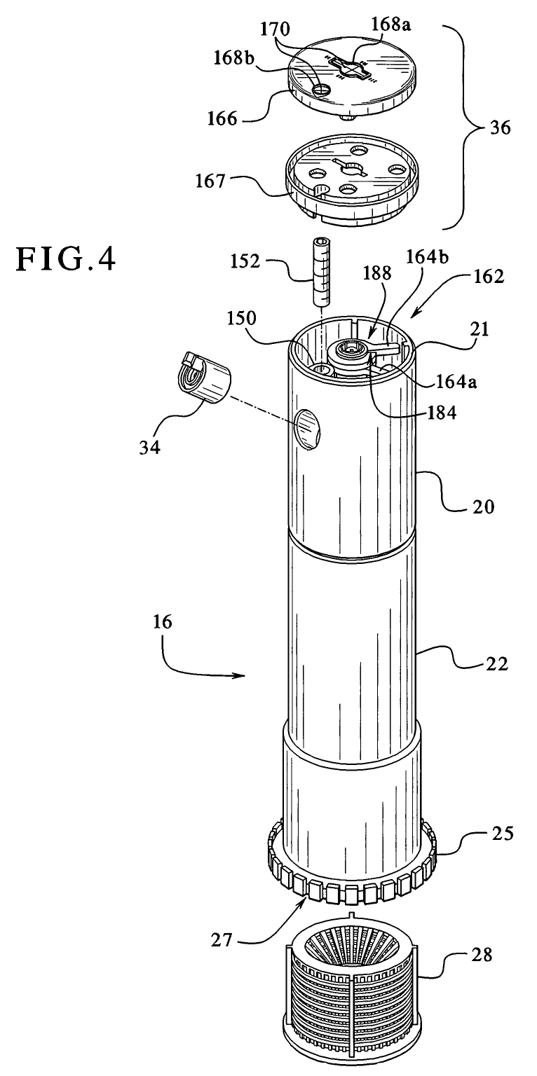

Referring now to FIGS. 1 to 5, in the illustrated embodiment, the inner housing or turret 16 slides relative to the outer housing 12 to move from a storage or non-operational position (in the outer housing as shown in FIG. 1A) to an operative position (fully extended from the outer housing as shown in FIG. 1). In the operative position, the inner housing emits or sprays water on a desired irrigation area or areas based on a desired spray pattern.

The inner housing 16 includes a head 20 and a body 22. The head 20 is rotatably connected to the body 22 and is operable to rotate or move with respect to the body when the pressurized water is communicated through the inner housing.

The head 20 and body 22 are formed with substantially the same diameter. The bottom of the body 22 includes a guide member such as an annular flange 25 integrally molded with the body 22. In one embodiment, the annular flange 25 defines a plurality of grooves 27 and specifically formed by the outside surface or perimeter of the annular flange. At least two of the grooves 27 slideably engage the longitudinal guides or fins 17 of the outer housing 12. The engagement of the guides and the guide member prevents rotational movement of the body 22 of the inner housing 16 with respect to the outer housing 12 while guiding the movement of the inner housing within the outer housing. It should be appreciated that any suitable number of guides may be formed on the inside surface of the body and any suitable number of co-acting grooves may be formed on the annular flange of the body. It should be appreciated that the annular flange 25 may include guides and the inside surface of the body may include a guide member or any suitable combination therein.

The outlet or nozzle 34 is removably attached to the head 20 and is adapted to receive the pressurized water from the interior of the head and emit or project the water from the head towards a desired irrigation area or areas. In the illustrated embodiment, the nozzle 34 is selected from a plurality of different nozzles defining different orifice or opening sizes based on the size of the water stream and amount of water which is desired to be emitted from the sprinkler. It should be appreciated that the nozzle 34 may be any suitable nozzle and may be any suitable size and shape.

In the illustrated embodiment, a flow distributor 125 is connected at the beginning or front of the outlet orifice member 148 to more evenly distribute the flow of the pressurized water directed to the nozzle 34. The flow distributor or distributor 125 includes at least one vane to re-direct the flow of the pressurized water as it enters the outlet orifice member 148. It should be appreciated that any suitable number of flow distributors may be connected to the outlet orifice member.

In the illustrated embodiment, a biasing member or spring such as coil spring 18 biases the inner housing 16 downwardly into the outer housing 12 to cause the inner housing 16 to move down into the outer housing when the pressurized water is drained or otherwise removed from the adjustable sprinkler. The bottom of spring 18 engages the top surface of the first guide member or annular flange 25. Initially, spring 18 is not compressed when the inner housing is retracted or positioned within the outer housing. As the inner housing 16 slides upwardly from the outer housing, the pressure of the incoming water causes the annular flange 25 to push against the bottom of the spring 18. The upward movement of the body 22 and the annular flange 25 caused by the water pressure compresses the spring 18. While compressed, the spring biases the annular flange downwardly into the outer housing. When the pressurized water is removed or drained from the adjustable sprinkler, the spring biases the top of the annular flange downwardly and causes the inner housing 16 to slide downwardly into the outer housing 12. It should be appreciated that the biasing member may be any suitable spring or any suitable shape or size which corresponds with the shape and size of the inner and outer housing.

In the illustrated embodiment, the positioner 14 is removably attached to the top of the outer housing to prevent the inner housing from separating from the outer housing. The positioner 14 also defines a generally centrally positioned opening through which the inner housing extends. The inner housing 16 slides upwardly and downwardly through this opening during operation as discussed above. Thus, the positioner 14 acts as a guide for the inner housing 16 to maintain the inner housing on a generally centrally positioned longitudinal axis extending through the center of the inner and outer housings. The positioner further provides a seal between the inner housing and the outer housing to substantially prevent water, particles such as sand or dirt, or other substances from getting between the inner and outer housings and potentially damaging the adjustable sprinkler.

In the illustrated embodiment, the positioner 14 includes a second guide member 23, a bearing sleeve 24 which fits into the second guide member, and a spring retainer 26 which fits into and frictionally engages the bearing sleeve. The second guide member, bearing sleeve and spring retainer co-act to perform the above functions of the positioner 14.

The second guide member 23 defines the centrally positioned opening which is adapted to receive and guide the inner housing 16. The second guide member is also securely attached to the top of the outer housing to hold or secure the bearing sleeve 24, the spring retainer 26 and the spring 18 inside the outer housing. In the illustrated embodiment, the second guide member 23 is generally molded of plastic and includes a first section 29a having a first diameter and a second section 29b having a larger second diameter. The first section of the second guide member 23 is formed to engage the top of the bearing sleeve 24. The inside surface of the second section 29b includes threads which are threadingly engaged with corresponding threads 21 formed on the outside surface of the top of the outer housing to securely attach the positioner to the outer housing.

The bearing sleeve 24 reduces the friction between the inner housing 16 and the positioner 14 as the inner housing slides upwardly and downwardly through the positioner. The bearing sleeve 24 also forms the seal between the inner housing and the positioner. In the illustrated embodiment, the bearing sleeve 24 is molded or formed with a generally upwardly extending wall 31 which is suitably sized to snap into or frictionally engage an inside surface of the first section 29a of the second guide member 23. The frictional engagement of the bearing sleeve 24 with the second guide member securely holds the bearing sleeve in place. An annular lip 33 is integrally formed at the bottom of the wall and is adapted to receive the spring retainer 26.

The spring retainer 26 is suitably sized to conform to the size of the spring 18 and hold the spring in place within the outer housing 12. In the illustrated embodiment, the bottom of the spring retainer 26 defines an annular region or area (not shown) that is adapted to receive the top of the spring and prevent the spring from detaching or separating from the spring retainer. The spring retainer 26 includes an annular wall or ridge 35 suitably sized to fit into the bottom of the bearing sleeve 24. The bearing sleeve 24 therefore locates or guides the spring retainer 26 in position inside the outer housing.

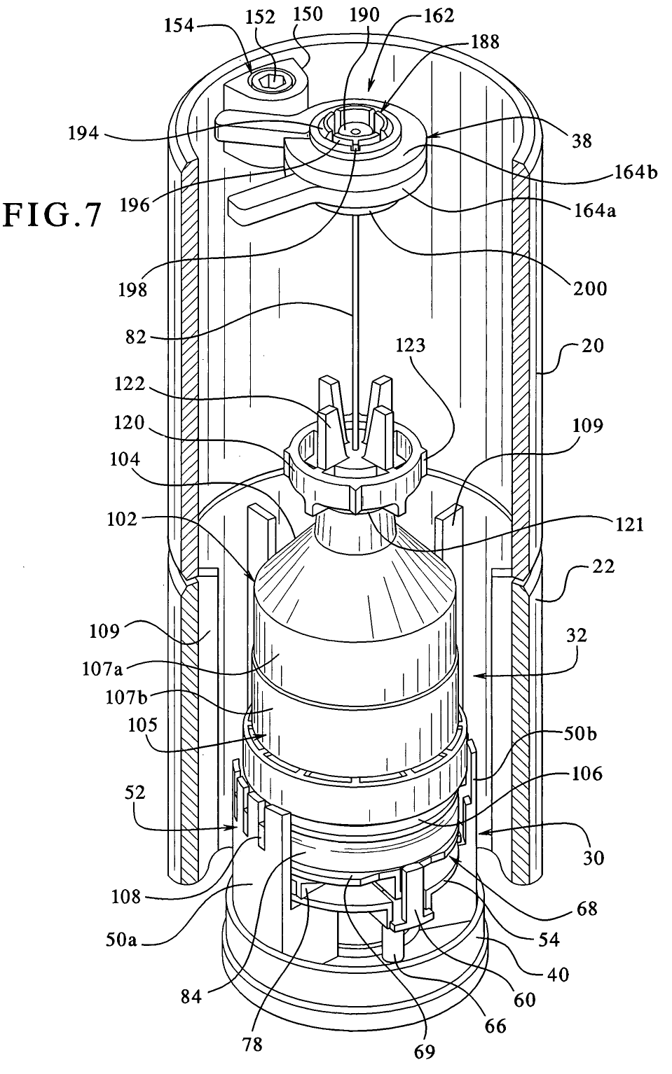

Referring now to FIGS. 5, 7 and 9, the adjustable sprinkler 10 includes a reversing mechanism or reverser 30, a driver or impeller 84, a gear reduction assembly or reducer 32, a rotary output member 120 and a selectively activated slip clutch 124 which are sequentially adjacently positioned inside the head 20 and the body 22 of the inner housing 16. The reverser, impeller, reducer and rotary output member co-act to independently rotate the head 20 in opposite directions within the set arc spray pattern and with respect to the body 22 utilizing the pressurized water received from the water pipe 13.

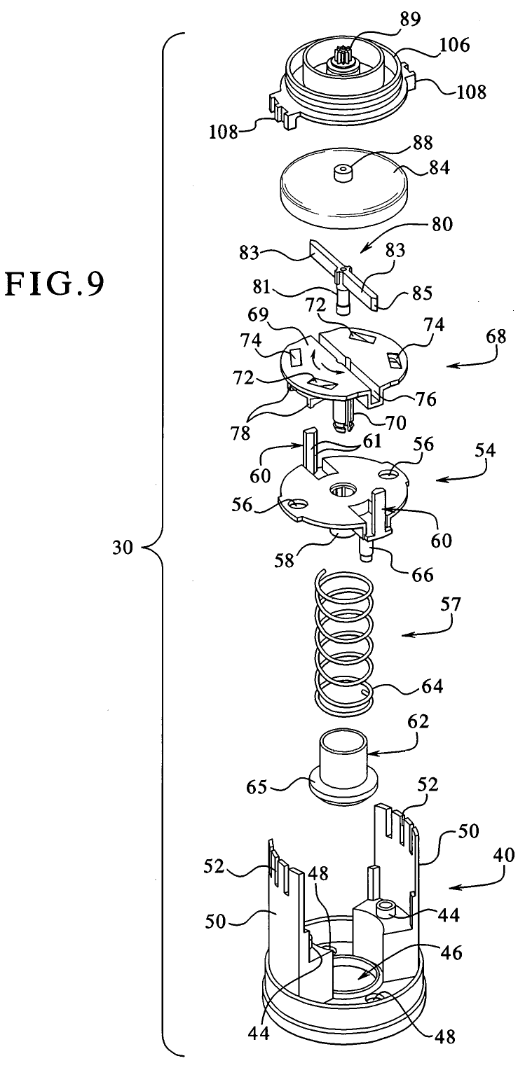

More specifically, the reverser 30 is operable to reverse or change the direction of the head 20 when the head reaches one of the boundaries of the spray pattern. In the illustrated embodiment of FIG. 9, the reverser 30 includes a retaining member, orifice plate or retainer 40 mounted to the bottom inside surface of the body 22, a mounting member 54 which is fixedly attached to the retainer 40, an oscillating member or oscillator 68 which is rotatably attached to the mounting member 54, a pivot member or lever 80 which engages a slot 76 defined by the oscillator 68 and an elongated shaft 82 which is fixed to the lever 80.

The retaining member or retainer 40 provides support for the various components of the adjustable sprinkler and maintains the vertical position of the reducer as described below. In the illustrated embodiment, the retainer 40 defines two fluid channels 42 that extend upwardly from the bottom surface of the retainer. The top of each of the fluid channels 42 includes a generally cylindrically-shaped fluid inlet 44, respectively, which is integrally formed with each of the channels. The fluid inlets 44 extend upwardly from the top of each of the channels 42 and extend or protrude above a surface of the retainer. The fluid inlets 42 direct the incoming pressurized water received from the outer housing 12 through the retainer.

The bottom surface of the retainer 40 defines a fluid bypass opening 46 adapted to receive pressurized water when the pressure of the water above the bypass opening reaches a designated water pressure which is less than the water pressure in front of or below the fluid bypass opening. The bottom surface of the retainer defines two support openings 48 adapted to receive corresponding support posts 66 of the mounting member as described below. The retainer includes two upwardly extending spaced apart walls 50 which each define a plurality of slots 52.

The mounting member or mounter 54 is fixedly attached to the retainer and provides support for and co-acts with the oscillator to change the rotational direction of the head 20. In the illustrated embodiment, the mounting member 54 includes two support holes 56 defined in the top surface of the mounting member, two support posts 66 integrally formed with and extending upwardly from the top surface and a bypass mechanism 57 movably attached to the bottom surface of the mounting member.

The support holes 56 of the mounting member 54 correspond to and are engaged by the protruding fluid inlets 44 of the retainer 40. The engagement of the fluid inlets 44 with the support holes 56 holds the mounting member 54 in position inside the body 22. The two downwardly extending support posts 66, engage the support openings 48 of the retainer. The support posts 66 are secured in the openings 48 by sonic welding or other suitable attachment method. The support posts 66 and the support openings 56 co-act to secure the mounting member 54 to the retainer 40.

The bypass mechanism 57 is adapted to supplement the amount of water directed to the nozzle in the head based on the size of the orifice or opening defined by the nozzle. Nozzles with smaller-sized orifices or openings project water from the nozzle a designated distance from the nozzle. The amount of water directed the smaller nozzles through the fluid inlets is adequate to supply enough water to the smaller nozzles to project the water the designated distance from the nozzle. However, nozzles having larger orifices or openings require more water to project the water from the nozzle at the same designated distance. Therefore, when a relatively larger nozzle is connected to the head the water pressure above the bypass mechanism decreases. The lower pressure above the bypass mechanism causes the higher water pressure in front of or below the bypass mechanism to push up and move the bypass mechanism 57 upwardly to enable more water to flow to the larger nozzle to maintain the same designated distance of projection of the water from the nozzle. In the illustrated embodiment, the bypass mechanism 57 includes a bypass hub 58, a bypass member 62 and a bypass spring 64.

The bypass hub 58 extends downwardly from the center of the mounting member 54 and to slideably engage the bypass opening 62. The generally cylindrical bypass member 62 extends downwardly from a point just below the bottom surface of the mounting member to the bottom surface of the retainer 40. The space between the bottom surface of the mounting member 54 and the bypass member 62 enables the bypass member to move upwardly and downwardly along the outside surface of the hub 58. The bottom end of the bypass member 62 includes a lip 65 integrally formed with and generally extending away from the bypass member.

The bypass spring 64 is positioned between the top surface of the lip 65 and the bottom surface of the mounting member 54. The bypass spring 64 biases the bypass member 62 downwardly away from the bottom surface of the mounting member to seat the bypass member in the bypass opening 46. The bypass member sealingly engages the bypass opening 46. The bypass spring 64 is formed to enable a designated or pre-determined water pressure to push against the bottom surface of the bypass member 62 and force or push the bypass member and spring upwardly towards the bottom surface of the mounting member 54 to allow additional water to be directed into the inner housing.

The mounting member 54 also includes upright posts 60 integrally formed with and extending upwardly from the top surface of the mounting member 54. The posts co-act with the lever 80 to change the direction of the head as described in more detail below.

The oscillator 68 is rotatably attached to the mounting member 54 and is operable to change the rotational direction of the driver or impeller 84. In the illustrated embodiment, the oscillator 68 includes a generally tubular hub 70 integrally formed with and extending downwardly from the bottom surface of the oscillator. The hub 70 is rotatably mounted to the bypass hub 58 of the mounting member 54. The oscillator 68 includes a generally circular base 69 extending outwardly from the hub 70. The base 69 includes two pairs of diametrically opposite fluid directing surfaces 72 and 74. In addition, the base 69 defines a generally horizontally extending slot 76. The width of the slot 76 is formed to receive the pivot member or lever 80 and to enable the lever to pivot within the slot as described in more detail below.

The oscillator 68 rotates or oscillates back and forth with respect to the mounting member 54. The oscillator includes four abutment walls 78 integrally formed with and extending downwardly from the bottom surface of the oscillator. The abutment walls 78 extend downwardly from the hub 70 and are positioned to limit the rotational or oscillating movement of the oscillator 68 with respect to the mounting member 54. Specifically, the abutment walls 78 are positioned so that one pair of abutment walls are located on either side of each of the fluid inlets 44. Accordingly, the oscillation or rotational movement of the oscillator 68 is limited by the distance between the inside surfaces of each pair of abutment walls 78. It should be appreciated that the distance between the abutment walls may be any suitable distance based on the desired rotational movement of the oscillator.

The reverser 40 includes the pivot member or lever 80 attached to the shaft 82 and operable to pivot within the slot 76 to cause the oscillator to rotate or oscillate. The lever 80 includes a hub 81 and a pair of arms 83 which extend outwardly from the hub.

The hub 81 extends downwardly from the pivot member and is inserted into and rotatably mounted to the hub 70 of the oscillator 68. The lever 80 has a width less than the width of the slot 76 to enable the lever to pivot within the slot. The free ends of the arms 83 include beveled surfaces 85. The beveled surfaces 85 engage corresponding surfaces 61 of the v-shaped upright posts 60. The upright posts 60 including the v-shaped surfaces are disposed in a first position where one of the surfaces of each post is in engagement with a corresponding beveled surface formed on each of the ends of the arms 83 of the lever. It should be appreciated that the cantilevered integral connection of the upright posts enables the posts to be resiliently moved from a first position in a direction diametrically apart to a second position against the normal bias of the posts. Accordingly, the normal bias of the upright posts serves to retain the pivot member of lever 80 in position. It should be appreciated that other bias means or methods can be utilized to retain the pivot member as desired.

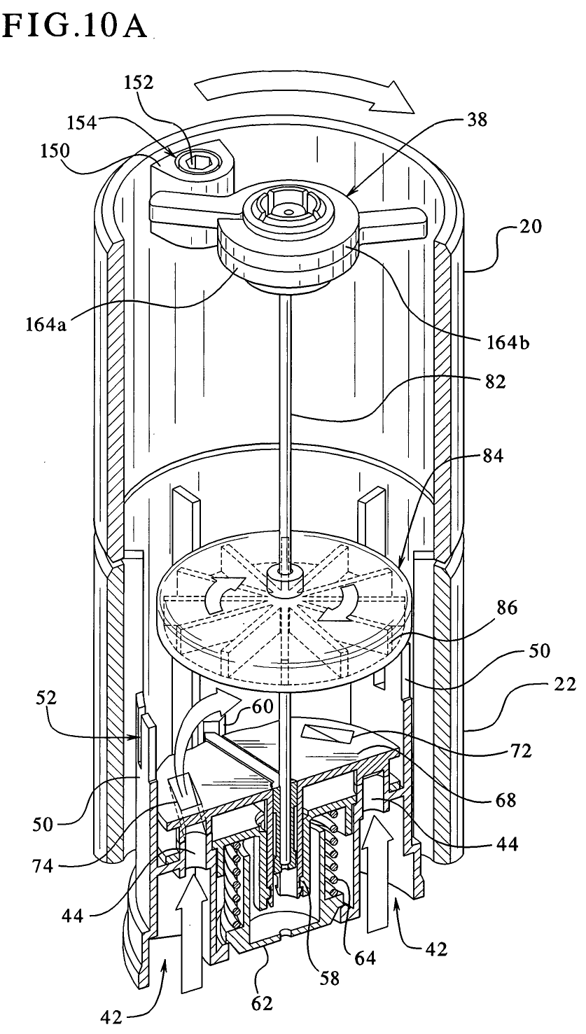

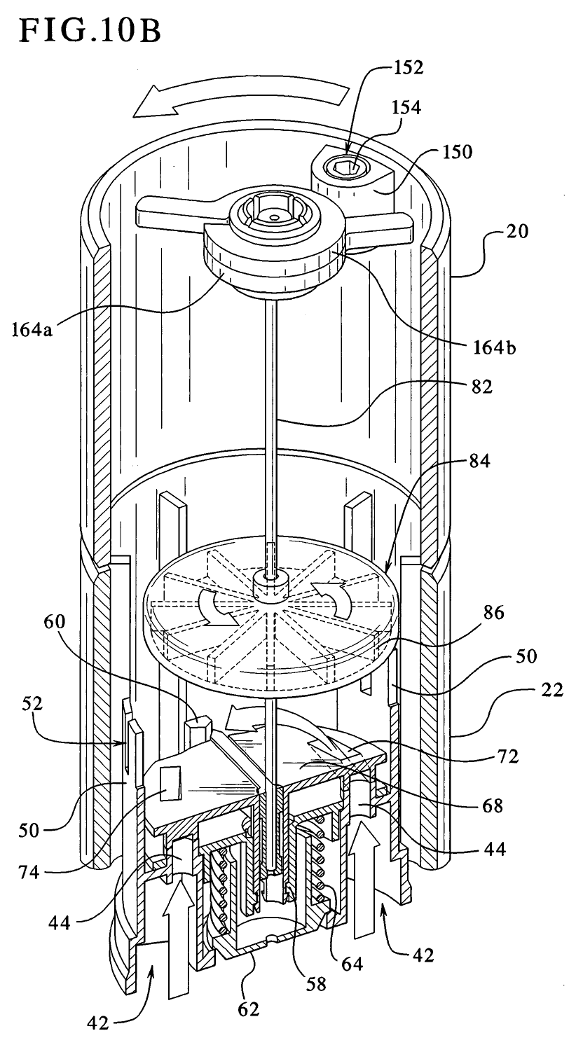

When the oscillator 68 is in a first position as shown in FIG. 10A, one of each pair of the fluid directing surfaces such as fluid directing surfaces 74 are positioned to receive the upperly directed fluid or water streams issuing from the fluid inlets 44. The fluid or water issuing from the fluid inlets 44 contacts the fluid directing surfaces 74. The fluid directing surfaces 74 direct the water against the bottom of the impeller 84 and specifically against the vanes 86 of the impeller. The deflection of the water streams issuing from the fluid inlets 44 by the pair of fluid directing surfaces 74 creates a reactionary hydraulic force on the oscillator 68. As a result, the impeller rotates in a clockwise direction. The clockwise rotation of the impeller causes the head to rotate in a clockwise direction as shown in FIG. 1A.

When the oscillator 68 is in a second or alternate position shown in FIG. 10B, the fluid inlets 44 are positioned adjacent to the fluid directing surfaces 72. The water issuing from the fluid inlets 44 contacts the fluid directing surfaces 72. The fluid directing surfaces 72 direct the water against the vanes 86 of the impeller 84 to cause the impeller to rotate in a counter clockwise direction. The counter clockwise rotation of the impeller causes the head to rotate in a counter clockwise direction as shown in FIG. 10B.

As described above, to prevent the movement of the oscillator 68 from moving beyond the first or second position described above, the oscillator is formed with the abutment walls 78 which engage the upper ends of the fluid inlets 44. It should also be appreciated that the oscillator 68 is moveable into an either the first or second position by causing the previously non-engaged beveled surfaces 85 on the ends of the lever arms 83 to engage the previously non-engaged v-shaped surfaces 61 of the upright posts 60.

Therefore, the oscillator 68 moves or rotates between two different positions to cause the head to rotate between the two different boundaries of a spray pattern. In a first position, the oscillator causes the head to rotate in a first direction such as a clockwise direction shown in FIG. 10A. In a second position, the oscillator causes the head to rotate in a second opposite direction such as a counter clockwise direction.

Referring now to FIGS. 5, 9, 10A and 10B, the reverser 30 includes an elongated shaft 82 which is operable to pivot the lever 80 when the head 20 reaches one of the boundaries of the designated or desired spray pattern. In the illustrated embodiment, the shaft 82 includes two opposing ends. The first end is fixed to the hub 81 of the pivot member or lever 80 where the axis of the shaft is aligned with the axis of rotation of the head 20 and the oscillatory axis of the oscillator 68. The second end or opposite end of the shaft is connected to the click set 38 positioned in the head 20 as described in more detail below.

A driver such as an impeller 84 is operable to rotate in opposite directions about the generally longitudinal axis extending generally through the center of the sprinkler to drive or rotate the head 20 in the same direction. The impeller 84 is positioned above the pivot member or lever 80 and is rotatably mounted on the shaft 82. The impeller includes a hub 88 rotatably attached to the reducer 32 described below. The impeller 84 includes a plurality of blades or vanes 86 integrally formed on its bottom surface. As described above, the vanes 86 are positioned to at least partially block or resist the fluid streams issuing from the fluid inlets 44 of the oscillator. The impeller rotates in a clockwise or counterclockwise direction depending on which pair of fluid directing surfaces 72 or 74 are in operative relation with the fluid inlets. When the oscillator 68 is in the first position shown in FIG. 10A, the impeller 84 rotates in a clockwise direction. When the oscillator is in a second position or opposite position to the first position shown in FIG. 10B, the impeller 84 moves in the opposite or counter clockwise direction.

Referring now to FIGS. 5, 7 and 8, the reducer such as the gear drive assembly or gear reduction assembly 32 is operable to reduce the rate of rotation transmitted to the reducer from the impeller 84 to rotate the head 20 at a designated or desired rate of rotation. The reducer 32 in the illustrated embodiment, includes a gear housing 102 having a stepped configuration and defines a hollow interior, a gear cover 106 which frictionally engages and seals the bottom of the gear housing, a series of planetary gears 110 which are positioned inside the gear housing, and a rotary output member 120 which is rotatably attached to the top end of the gear housing.

The gear housing 102 includes an upper end 104 and a lower end 105 where the lower end has a first section 107a having one diameter and a second section 107b having a different diameter. The diameter of the second section 107b is generally larger than the diameter of the first section and is sized to frictionally engage the logitudinally spaced apart ribs or fins 109 formed on the inside surface of the inner housing 16. The frictional engagement of the gear housing 102 with the longitudinal fins causes the gear housing to remain stationary during operation of the adjustable sprinkler and move in accordance with the movement of the head 20 when the head is manually rotated or turned in either direction. The stepped configuration of the gear housing therefore enables a user to smoothly and accurately rotate or turn the head including the nozzle to verify the boundaries of the spray pattern as described in further detail below.

The gear cover 106 is formed to fit into and frictionally engage the bottom end of the gear housing 102. The gear cover 106 includes a plurality of spaced apart lugs 108 which fit into and engage the corresponding slots 52 on the walls 50a and 50b of the retaining member 40. The engagement of the lugs 108 with the slots 52 maintains the vertical position of the gear housing and the rotary output member 120 in the body 22.

A plurality or series of planetary gears 110a, 110b and 110c are positioned inside the gear housing 102 to reduce the rotational movement or rotational rate transferred to the gear housing from the impeller 84. Each of the planetary gears 110a, 110b, and 110c includes a gear carrier 112, a sun gear 114 integrally formed on the top surface of the gear carrier, and at least two gears 116 rotatably connected to the bottom surface of the gear carrier 112. Each of the gears 116 include gear teeth 117 which engage corresponding protrusions or teeth (not shown) formed on the inside surface of the gear housing 102. In this embodiment, the gear housing 102 includes three planetary gears 110a, 110b and 110c. It should be appreciated that any suitable number of planetary gears and sun gears may be employed in accordance with the present invention. In this embodiment, the gears 116 on the first planetary gear 110a engage a corresponding sun gear 89 integrally formed on the end of the hub 88 of the impeller 84.

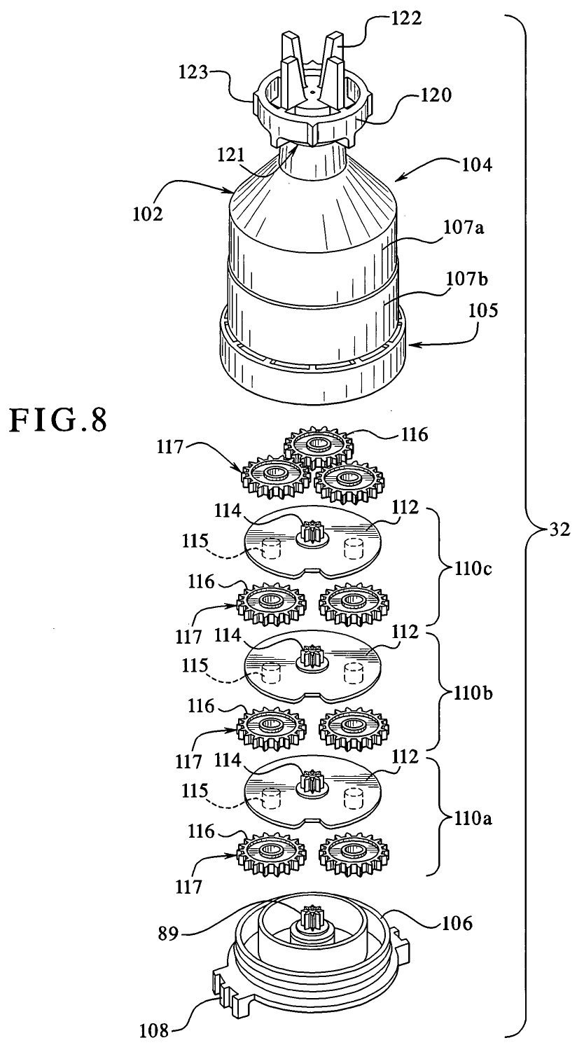

As best illustrated in FIGS. 8 and 9, the hub 88 of the impeller 84 extends through an opening defined in the center of the gear cover 106. A sun gear 89 is integrally formed with the hub 88 on the inside or opposite surface of the gear cover from that of the impeller. The sun gear 89 is adapted to engage the gears 116 of the first planetary gear 110a inside the gear housing 102. The sun gear 89 rotates in the same direction and at the same rotational rate as the impeller 84 and transfers these rotational movements to the first planetary gear 110a. In turn, the sun gear 114 formed on the first planetary gear 110a engages the gears 116 on a second planetary gear 110b. The sun gear 114 on each subsequent planetary gear 110 engages the next set of gears 116 on each subsequent planetary gear 110. The final planetary gear 110c engages a plurality of gears 116 including hubs (not shown) which are fixedly attached to or secured to the bottom of the rotary output member 120.

The rotary output member 120 is operable to rotate at the same rate of rotation and in the same direction as the final planetary gear 110a. The rotary output member 120 includes an annular bearing 121 positioned between the rotary output member and the top of the gear housing 102 to minimize the friction between the rotary output member and the gear housing. The rotary output member 120 includes a plurality of generally vertical members 122 integrally formed with the top surface of the rotary output member. The vertical members 122 are positioned to fit within the spring 146 to guide and maintain the spring in position.

Referring now to FIGS. 5 and 8, the selectively activatable slip clutch 124 is operable to transfer or transmit the rotation of the rotary output member to the head 20 when the reducer does not rotate due to a malfunction or other problem. Similar to the reducer, the selectively activatable slip clutch enables the head to be manually rotated without damaging any of the internal components of the sprinkler. In the illustrated embodiment, the slip clutch 124 is integrally formed with the rotary output member 120 and includes projections (not shown) which engage teeth (not shown) formed on the inside of the head mount 126 to releasably hold the slip clutch in place. When the rotational force of the head is equal to or greater than a designated level of force, the gear housing rotates to enable the head to be manually turned or rotated without damaging the reverser and other internal components of the sprinkler. If the gear housing is stuck in position or otherwise cannot turn or rotate due to some other problem or malfunction, the slip clutch turns or rotates to enable the head to be manually rotated without damaging the internal components of the sprinkler. The slip clutch is accordingly selectively operable.

The head mount 126 has a radially outwardly extending flange 140 integrally formed at its lower end and an annular seal and washer assembly 142 positioned between the flange and the adjacent inside surface of the body 22. The head mount 126 includes an interior integrally formed flange 144 against which one end of a coil spring 146 is engaged. The opposite end of the coil spring 146 is engaged with the slip clutch 124. The spring 146 biases the head mount 126 downwardly to sealingly engage the flange 140 with the seal and washer assembly 142.

The head 20 is attached to the head mount 126. Therefore, the head 20 is operable to rotate at the same rate of rotation and in the same direction as the head mount and the rotary output member. The head 20 is formed with integral interior walls which fixedly interconnect, as by ultrasonic welding, with the upper end of the head mount 126 and direct the flow of pressurized water upwardly and outwardly to the outlet orifice member 148. The outlet orifice member 148 includes the nozzle 34, which is selected from a plurality of different sized nozzles, where the nozzle is removably mounted within the walls of the orifice member 148. The head 20 also includes a boss or stop 150 which is integrally formed on the inside surface at the top of the head. An adjustment screw 152 is threadingly engaged with a corresponding receptacle 154 defined in the stop and acts to retain the selected nozzle 34 in position during the operation of the adjustable sprinkler. The lower end of the screw 152 is adjusted downwardly into at least a portion of the fluid stream emitted from the nozzle 34 to act as a water stream diffuser or water stream deflector to vary the water spray emitted from the nozzle.

The head defines a longitudinal opening therethrough which is adapted to receive the shaft 82. As shown in FIG. 5, an o-ring 156 is positioned between the exterior periphery of the shaft 82 and the opening in the interior wall of the head 20 to form a suitable seal. An inner member or fitment 158 is attached to the upper end of the shaft 82. The fitment 158 is retained in position by an outer member or skirt 160 which is in frictional or snap-fit engagement with the fitment.

Referring now to FIGS. 5, 7, 8, 10A, 10B and 11, a spray pattern adjustment mechanism or spray pattern controller 162 is attached to the fitment 158 and is operable to set the first and second boundaries of a designated or desired spray pattern. The spray pattern controller 162 includes a click set mechanism or click set 38. The click set 38 is operable to adjust and set the oscillation limits of the reverser 30 to effect reversal of the reverser. To prevent access to the interior of the head 20 and prevent the purposeful or accidental manual re-positioning of the click set, a cap or cover 36 is fixed to or fixedly attached to the top of the head 20.

As best shown in FIGS. 5, 7, 10A and 10B, the shaft 82 couples the spray pattern controller or click set with the reverser. Specifically, the first or second adjustment member 164a or 164b is contacted by the stop 150 (i.e., the first or second boundary of the spray pattern is reached), the stop pushes against the first or second adjustment member. The rotational pushing force against the first or second adjustment member by the stop is transferred to the shaft. The shaft transfers the rotational force to the lever of the reverser, which causes the lever to pivot within the slot. The pivoting of the lever causes the oscillator to move to a different position and thereby changes the direction of the impeller and the head. Thus, the shaft 82 transfers the rotational force or torque created by the stop or boss 150 when the stop contacts one of the first and second adjustment members 164a or 164b to the reverser to change the direction of the head.

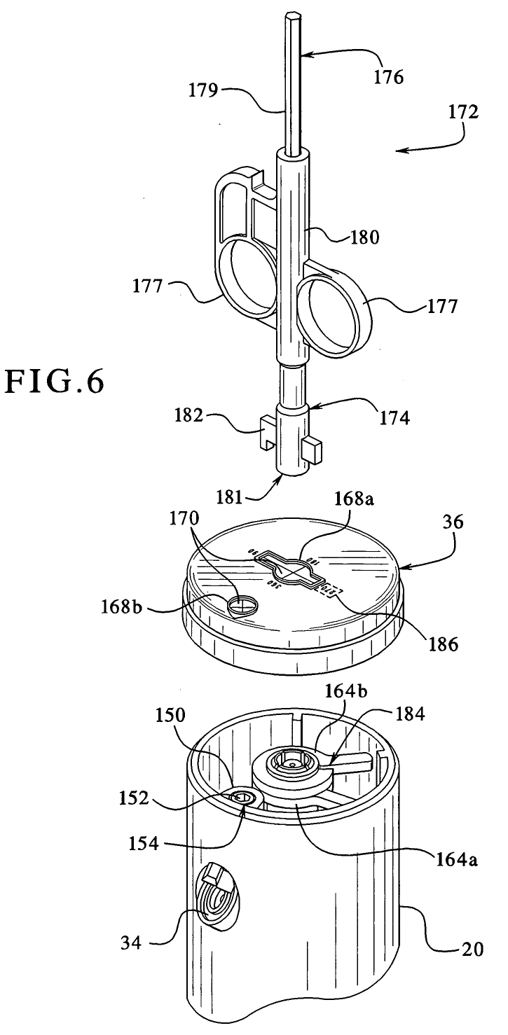

Referring now to FIGS. 1, 2, 4 and 5, the cover or cap 36 includes a cover member 166 defining two openings 168a and 168b therethrough. Each of the openings 168a and 168b include movable flaps 170 which cover the openings to prevent dirt, sand or other particles from entering the cap and potentially causing malfunction of the sprinkler gear drive components located inside the head 20. The first opening 168a is formed to enable a first end 174 of an adjustment tool or adjuster 172 (best shown in FIG. 6) to be inserted into and through the cover or cap 36 to engage the click set 38. The second opening 168b enables a second end 176 of the adjustment tool to be inserted into and through the cover 36 to engage the screw 152 seated in the stop 178 integrally formed on the inside surface of the head 20 as described above. In one embodiment, the adjuster includes a handle such as the two finger grip members or finger grips 177 to enable a user to hold and manipulate the adjuster. It should be appreciated that the handle may include any suitable number of finger grips. It should also be appreciated that any suitable handle, grip or any other suitable handle device may be attached or otherwise formed on the adjustment tool.

Referring now to FIGS. 5, 6, 7 and 11 in one embodiment, a shaft cap 156 is attached to the top of the shaft to hold the click set. A cap retainer 161 is positioned over the shaft cap and secures the shaft cap to the bottom surface of the interior of the head 20. The click set 38 is positioned on the shaft cap 156 and includes an inner member or fitment 158, which is molded of plastic material and includes a hollow hub portion 190 having an annular flange 192 extending radially outwardly from one end thereof. The opposite end of the hub portion 190 is slotted at annularly spaced apart positions to form integral spring fingers 194 on the outer section of the hub portion 190. Spring fingers 194 have attaching lugs 196 extending outwardly therefrom and are shaped to provide locking surfaces. One of the spring fingers 194 includes a projection 198 at the outside top surface of the spring finger at generally the same level as the position of the lug 196.

The click set 38 also includes an outer member or skirt 160, which includes a tubular hub portion 202 having an annular flange 204 extending radially outwardly from one end of the hub portion. The hub portion 202 includes an inner peripheral surface of a designated size to engage the exterior peripheral surface of the hub portion 190 of the inner member 188 and an exterior surface formed with a series of annularly spaced v-shaped ridges 206 extending axially along the surface. In addition, the interior surface of the hub portion 202 which is adjacent to the flange 204, includes a recess 208 defined on the flange and formed to matingly engage the projection 198 on the fitment.

The click set 38 further includes a first adjustment member 164a and a second adjustment member 164b formed of suitable material such as plastic. Each adjustment member includes one long end portion 210 and a short end portion 212. The interior surface of the adjustment members 164a and 164b are formed with serrations 214 which cooperate with the ridges 206 on the exterior or outside surface of the outer member 200.

The above components or parts of the click set 38 are assembled by engaging the two adjustment members 164a and 164b on the periphery of the fitment 160 and then sliding the fitment and the skirt into cooperating positions on the fitment during which the interior periphery of the fitment 160 engages the lugs 196 and deflects the spring fingers 194 radially inwardly until the lugs 196 reach the end of the hub portion 202 of the fitment 160 and spring outwardly so as to keep the parts together.

Initially, the click set 38 initially rests on top of the shaft 82 on the shaft cap 156 (i.e., in a non-engaged position with the shaft). In this position, the click set sets and provides a continuous 360 degree spray pattern. Therefore, if a installer or other user of the present invention desires a 360 degree spray pattern, the installer connects the adjustable sprinkler to the pipe and does not adjust either of the boundaries of the click set. If the user or installer desires a spray pattern less than 360 degrees, the user inserts the adjustment tool or adjuster 172 through the cap 36 to engage and push the click set 38 down into engagement with the shaft cap 156 on the shaft 82. This enables the user to set the boundaries to form any desired part circle spray pattern.

When the click set is in the shaft engaging position, the first adjustment member 164a is fixed at assembly and therefore remains generally in the same position or place with respect to the click set. To set the first boundary of a desired spray pattern, the first adjustment member 164a is aligned with the first boundary of the desired spray pattern by manually turning the adjustable sprinkler 10 on the water pipe 13 until the first adjustment member 164a. The adjustable sprinkler may be rotated in a clockwise or counter clockwise directions with respect to the water pipe until the first adjustment member is aligned with the first boundary. It should be appreciated that the water pipe includes a nipple or other suitable extension having sufficient threads to enable the adjustable sprinkler 10 to be rotated in either direction on the water pipe to align the first boundary of the spray pattern without causing any water leaks due to an inadequate seal between the adjustable sprinkler and the water pipe.

The second adjustment member 164b is adjustable or movable to a certain position with respect to the click set to set the second boundary of the spray pattern. Specifically, the second or other boundary of the spray pattern is set by adjusting the location or position of the second adjustment member 164b using the adjustment tool or adjuster 172. It should be appreciated that a non-continuous or reversible 360 degree spray pattern can be set when the click set is engaged with the top of the shaft 82 by adjusting the second adjustment member 164b to be at the furthest position away from the first adjustment member using the adjuster 172. If the 360 degree spray pattern is set in this manner, the stop rotates back and forth between the adjustment members to form the 360 degree spray pattern. It should be appreciated that although the stop 150 rotates back and forth between the two boundaries and does not make a complete revolution, the width of the spray emitted from the nozzle enables the adjustable sprinkler to spray water in a 360 degree spray pattern.

The adjuster 172 enables a user to manually adjust one of the boundaries of the spray pattern. The adjuster includes a body 179 and an attachment 180 connected to the body 179. It should be appreciated that the attachment 180 may be integrally formed with the body 179 and may be made with any suitable material such as plastic. The attachment 180 defines a receptacle 181 and includes an arm 182 integrally formed with and generally extending horizontally from the shaft body. The receptacle 181 is formed to engage the top of the shaft 82 on which the click set 38 is seated to enable the adjuster to engage and control the click set as well as hold the click set in place to prevent activation of the memory clutch which is described in more detail below. Otherwise, the manual turning or rotation of the head while verifying the boundaries of the desired spray pattern, could cause the memory clutch to activate and make determining the boundaries of the spray pattern more difficult and time consuming. The arm 182 is formed to engage a slot 184 defined in the click set 38 to control the movement of the second adjustment member 164b.

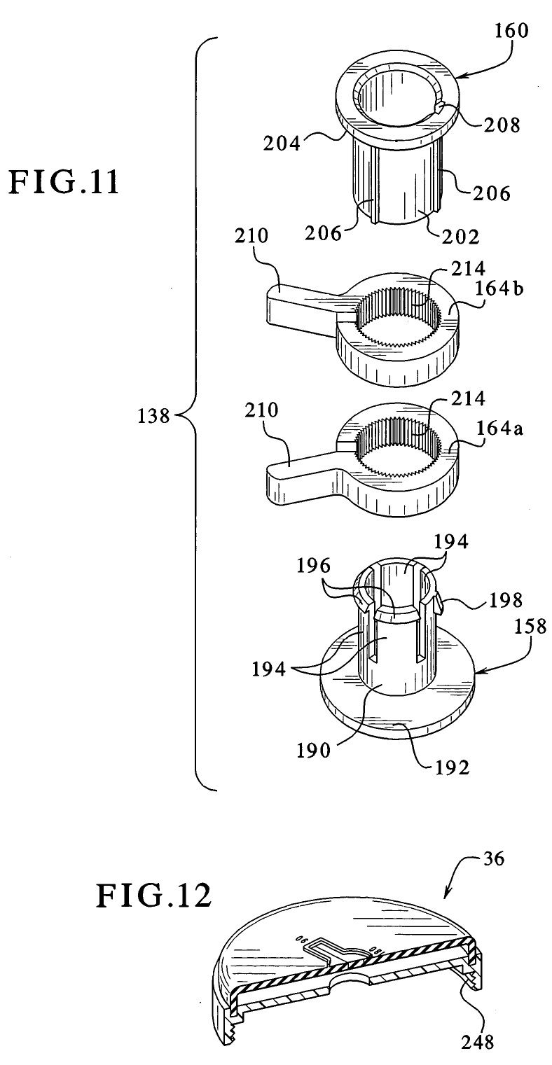

Referring now to FIG. 11, the memory clutch is operable to cause the head to rotate or move back into position between the spray pattern boundaries after the head is manually moved beyond those boundaries. The operation of the components which co-act to form the memory clutch is described below.

The rotational movement between the fitment 158 and the skirt 160 causes the projection 198 to engage the recess 208 and thereby cause the first and second adjustment members to rotate in unison according to the designated spray pattern. When the head 20 is manually rotated by a vandal or other person beyond one of the set boundaries of the spray pattern, the projection 198 dis-engages from the recess 208 and causes the temporary disruption of the spray pattern. The recess 208 continues to rotate with the fitment 160 (i.e, independently from the skirt 158 which is not moving or rotating) until the recess 208 rotates into re-engagement with the projection 198 to hold or join the fitment and skirt together again. The arrangement of the fitment and skirt is therefore one which is operable to: (1) engage and transmit rotational movements of the fitment 160 in either direction to the skirt 158 during operation of the adjustable sprinkler; and (2) dis-engage in response to a manual or forced rotation of the head which overrides the rotational movements of the fitment 160 in either direction so as to enable the fitment 160 to be manually moved independently from the skirt 158.

As described above, the adjustment tool 172 engages the click set 38 to hold the click set in place and prevent the projection 198 from disengaging from the recess 208 when the installer manually rotates the head to verify the boundaries of the spray pattern.

Referring now to FIGS. 2, 4 and 6, the top surface of the cover 36 includes at least one and preferably a plurality of spray pattern indicators 186 (best seen in FIG. 6) which indicate different spray pattern settings for the sprinkler. The indicators 186 generally include spray pattern settings of 90 degrees, 180 degrees, 270 degrees and 360 degrees. It should be appreciated that the spray pattern settings may include any suitable spray pattern settings desired. In one embodiment, a user inserts the adjustment tool or adjuster 172 through the cover 36 and engages the click set 38 until the arm 182 of the tool engages or is seated in the slot 184 of the click set. The user then manually rotates or turns the adjustment tool until the plane of the adjustment tool is aligned with the indicator 186 of the desired spray pattern. The adjustable sprinkler rotates and emits water from the nozzle according to the spray pattern set by the user. It should be appreciated that the adjustment tool 172 may include one or more spray pattern identifiers (not shown) such as a protrusion in the form of an arrow or the like to identify an indicator aligned with the adjustment tool.

As described above, the present invention enables a user to manually adjust the spray pattern boundaries for an adjustable sprinkler without requiring the user to remove the cap or cover 36 to set the desired spray pattern for the adjustable sprinkler. The present invention therefore saves significant time in the field because different spray patterns can be easily and quickly set using the adjustment tool 172 without having to remove and replace the cover 36 each time an adjustment or modification to the spray pattern is desired. The time savings is even more significant in a sprinkler system including several adjustable sprinklers.

Additionally, after the arc spray pattern or spray pattern is set on a particular adjustable sprinkler, the present invention enables the user to hold the head 20 and smoothly and continuously rotate the head to rotate the adjustment members 164a and 164b of the click set 38 to identify and verify the boundaries of the set spray pattern without damaging the internal components of the adjustable sprinkler 10 or accidentally changing the spray pattern. This further minimizes the time required in the field to verify the spray patterns set on one or more adjustable sprinklers 10 and enables a user to be able to quickly and easily make further adjustments to the spray pattern as necessary. Specifically, when a user rotates the head 20 past one of the adjustment members 164a or 164b to verify the position of the adjustment member, the torque or rotational force of the movement of the head is transferred to the shaft and thereby to the reducer which rotates when the manual force exceeds a designated level. This enables the user to manually rotate the head as described above to verify the boundaries of the spray pattern.

It should be appreciated that in the above embodiments, the outer housing 12, the cap 14 and the inner housing or turret 16 and the other parts of the adjustable sprinkler 10 are preferably made of a durable plastic. It should be appreciated, however, that one, a plurality or all of these components may be formed using any suitable material.

### Operation

Referring now to FIGS. 1 to 5, 10A, 10B and 11, the adjustable sprinkler 10 is shown attached to a pressurized water pipe such as water pipe 13. Initially, the click set is in a non-engaged position with respect to the shaft 82. In the non-engaged position, the head rotates in a continuous 360 degree spray pattern. Therefore, if a user such as an installer desires a continuous 360 degree spray pattern, the user does not have to adjust the adjustable sprinkler 10 after it is connected to the water pipe. If the user desires a part circle spray pattern (i.e., less than 360 degree spray pattern) the user inserts the adjuster 172 into and through the cap 36 to engage the click set 38. The adjuster and particularly the hub 181 of the adjuster engages the click set 38 and the installer pushes down on the adjuster to push downwardly on the click set to engage the click set with the shaft cap 156 on the top of the shaft 82.

When the click set is engaged with the top of the shaft, the user or installer turns the adjuster to correspondingly turn the second adjustment member 164b of the click set. The second adjustment member 164b is rotated to set the second boundary of the spray pattern. After the second boundary of the spray pattern is set, the user or installer turns a valve or similar device to cause the water to enter the sprinkler from the water pipe. The installer then manually rotates the head 20 to each of the set boundaries to identify and verify the location of the boundaries. Thus, the installer can see where the water stream, which is projected from the nozzle 34, is going to further refine the location of the boundaries. Alternatively, the installer can perform the initial steps of setting the boundaries of the spray pattern after the valve is turned or opened to cause the water to enter the adjustable sprinkler. The following paragraphs further describe the operation of the sprinkler.

When the pressurized water is turned off from pipe 13, the adjustable sprinkler 10 moves to its lowered storage position, as shown in FIG. 5, due to the bias of spring 18. When the pressurized water is turned on or activated, the pressurized water is supplied from the pipe 13 to the inlet of the outer housing. Initially, the pressurized water acts on the bottom of the body 22 to move the body 22 and head 20 upward. Water enters the interior of the outer housing 12 and passes through the screen 28 to the interior of the body 22. By virtue of the seal provided by the bearing sleeve 24, the pressurized water in the outer housing 12 acts on the bottom of the body 22 to slideingly move the body to its popped-up or operative position as shown in FIG. 1.

In this position, the bearing sleeve 24 prevents the flow of the pressurized water between the body 22 and the outer housing 12. The pressurized water within the body 22 first flows through the screen 28 and then to the fluid inlets 44 and ultimately to the nozzle 34. When a nozzle 34 includes a relatively small outlet opening or orifice, the bypass member 62 generally remains closed or seated in the bypass opening 46. The bypass member 62 opens when the outlet size of the nozzle is near the upper limit of a range provided. If the reverser 30 is in the position shown in FIG. 10A, the impeller 84 moves in the direction of the water flow to rotate in a clockwise direction as described above. The rotational movement of the impeller 84 is transmitted through the gear assembly 32 to the rotary output member 120 in a corresponding direction but at a significantly lesser speed. The rotational movement of the rotary output member 120 is then transmitted to the head 20 through the selectively activatable slip clutch 124. The pressurized water therefore flows through the fluid inlets 44 of the retainer 40 and upwardly along the exterior of the gear housing 102, past the selectively activatable slip clutch 124 and finally upwardly into the head 20 and out of the orifice or outlet of the nozzle 34 so as to direct the pressurized water from the nozzle to a designated irrigation area.

The rotational movement transferred to the head 20 by the corresponding rotation of the impeller 84 and the operation of the gear assembly 32 serves to move the discharging stream in a corresponding counterclockwise direction as viewed from above. As the head 20 continues to move, the stop 150 formed on the inside surface of the head 20 rotates as the head rotates and engages one of the first and second adjustment members 164a or 164b depending upon the spray pattern setting. When the stop 150 engages the first adjustment member 164a, the rotational movement is transmitted through the serrations 214 and the ridges 206 to the fitment or outer member 160 of the spray pattern controller 162 which, in turn, by virtue of the engagement of the projection 198 within the recess 208 is transmitted to the inner member or skirt 158. Since the skirt is keyed to the fitment on the shaft 82, the shaft 82 turns which correspondingly turns the lever 80 of the gear assembly 30. The lever pivots within the slot defined in the oscillator to correspondingly turn or pivot the lever arm. The pivoting lever arm pushes against the opposing walls or surfaces that define the slot, and pivots or turns the oscillator to change the position of the pairs of fluid directing surfaces adjacent to the fluid inlets. This causes the oscillator to reverse the direction of the impeller, which causes the head to also reverse direction. This process continues until the oscillation is complete.

As best be seen in FIG. 10A, the initial movement of the lever 80 results in an initial movement of the oscillator 68. During this initial movement of the lever 80, the posts 60 move from their first positions radially outwardly into their second positions against their natural bias. When the engaged beveled surfaces 85 on the ends of the lever 80 and the posts disengage, the resilient bias of the posts 60 tend to move the posts back into their first positions, so as to engage the beveled surfaces 85. The engagement of the surfaces causes the lever 80 to rapidly advance the oscillator member 68 and bring the fluid directing surfaces 72 or 74 into the water streams issuing from the fluid inlets 44. When the opposite fluid directing surfaces are engaged to an extent greater than the initial fluid directing surfaces, the hydraulic forces move the oscillator 68 into its opposite limiting position.

Referring to FIG. 10B, when the oscillator 68 is in the reverse or opposite position, the water flow causes the impeller 30 to move counterclockwise when viewing the impeller from above. The counterclockwise movement of the impeller, in turn, reverses the direction of the rotational movement of the head 20 to rotate in a counterclockwise direction as viewed from above. Thus, the pressurized water stream discharging from the nozzle 34 is now directed within one limit of the set or designated spray pattern and correspondingly moves in the counterclockwise direction with the rotational movement of the head 20. It should be appreciated that the second adjustment member 164b is readily adjusted by moving the big end portion 210 in an annular direction opposite to that which it would be engaged by the movement of the head structure 20 using the adjustment tool or adjuster. The arrangement is such that movement in one direction tends to lock the serrations 214 with the ridges 206 while movement in the opposite direction tends to separate the serrations from the ridges and thereby allow the second adjustment member to move or rotate.

It should be appreciated that the reducer 32 achieves a substantial reduction in the rotational speed or rate while preventing rotational movement in a direction opposite to the intended or drive direction of the components. In other words, if the head 20 were keyed directly to the rotary output member 120, then the head 20 could not be moved manually without damaging the gear assembly or other components of the adjustable sprinkler. By providing the gear housing 102 including the two sections having different diameters, any unwanted or forced manual movement of the head 20 results in the independent turning of the head 20 with respect to the body 22. The reducer and more specifically, the gear housing 102 operates so that the larger second diameter of the lower portion of the gear housing 102 frictionally engages the fins formed on the inside surface of the body 22 to enable the gear housing, and also the rotary output member and head, to slideingly move or rotate with respect to the body 22.

The configuration of the gear housing enables a user to manually rotate or move the head 20 to cause the engagement of the stop 150 with the first or second adjustment member 164a or 164b and thereby identify and verify the boundaries of the designated or desired spray pattern. Rotating the head 20 in this manner maintains the engagement of the serrations 214 of the second adjustment member 164b with the ridges 206 of the outer member 200 and thereby rotates or turns the head 20.

Alternatively, if the reducer or more specifically, the gear housing 102 becomes stuck or otherwise does not rotate, the selectively activatable slip clutch 124 rotates to enable the head 20 to rotate upon the manual turning or rotation of the head. The slip clutch 124 includes a plurality of protrusions 123 adapted to engage corresponding teeth formed on the inside of the head mount 126. The protrusions 123 hold the slip clutch 124 during operation of the adjustable sprinkler and move successively along the teeth as the head is manually rotated to prevent the internal components of the adjustable sprinkler from being damaged. Therefore, the selectively activatable slip clutch 124 only functions or moves when the stop 150 is rotated past one of the adjustment members 164a or 164b and the reducer is stuck or otherwise does not move or rotate.

When the manual movement or rotation of the head 20 ends and the head is at a position outside of the boundaries set for the designated spray pattern and when operation of the adjustable sprinkler resumes, the head 20 moves in the same direction as the present rotational direction of the rotary output member. The head 20 thereby moves or rotates until the outer member 200 and the inner member 188 rotate into a position in which the projection 198 re-engages the recess 208. In this position, the continued rotational movement of the head 20 correspondingly moves the skirt 158 which, as previously described, causes the reverse movement of the rotary output member, thus automatically returns the head 20 into operation between the previously set limits or boundaries of the designated or desired spray pattern.

### Alternative Embodiments

Referring now to FIG. 12, in one alternative embodiment, the cap or cover 36 and the top of the head are configured to include meshing threads 248 to enable the cap to be screwed onto and off of the top of the head. The threads prevent the cap from popping off when the lines in the sprinkler system are blown out with air in the colder winter months and enables a user to be able to easily remove and replace the cap on the head.

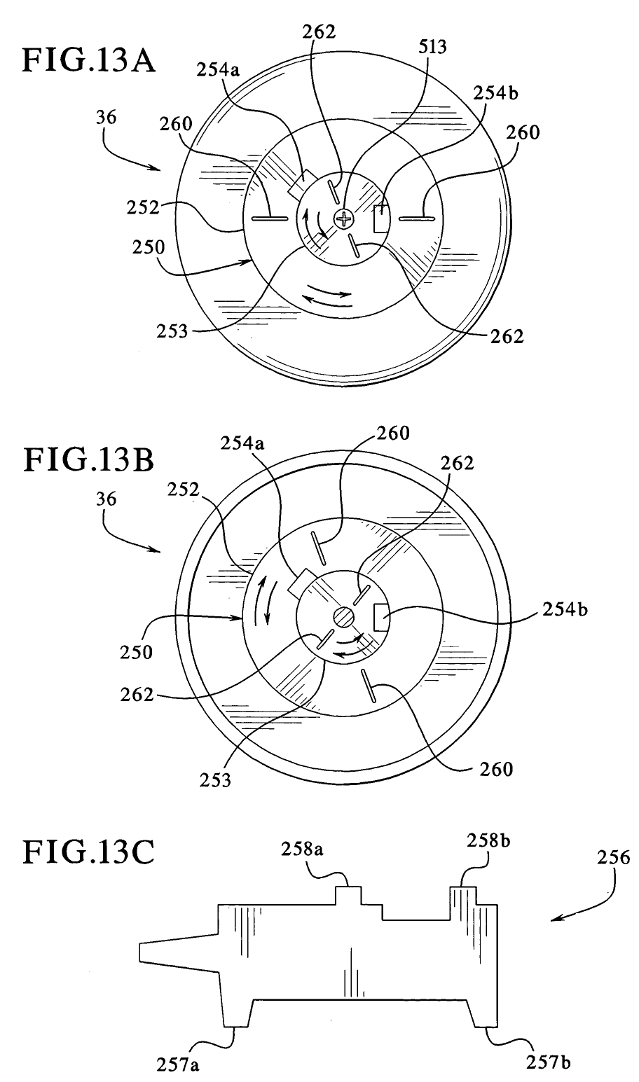

Referring now to FIGS. 13A, 13B and 13C, in another alternative embodiment, the cap 36 includes a clear portion 250 having first and second concentric rings 252 and 253, respectively. The bottom of each ring (i.e., the bottom of the cap) includes a generally rectangular post 254a and 254b, which each take the place of the first and second adjustment members 164a and 164b as described above. A user uses a key 256 including a set of outwardly spaced tabs 257a and 257b on one side of the key and a set of inwardly spaced tabs 258a and 258b on the opposite side of the key to remotely adjust the boundaries and specifically, the posts 254 of a desired spray pattern. The outwardly spaced tabs 257a and 257b of the key 256 engage corresponding slots 260 on the top surface of the outer clear ring 252. Once engaged, the key 256 is turned in either direction to adjust the position of the post 254a attached to the bottom of the outer ring 252 to set one of the boundaries of the desired spray pattern. The key 256 is then flipped over to engage the inwardly spaced tabs 258a and 258b of the key with corresponding slots 262a and 262b on the top surface of the inner ring 252b. The key 256 is turned in either direction to adjust the position of the post 254b attached to the bottom of the inner ring 252b to set the other boundary of the arc spray pattern. In addition, the rings 252 and 253 are clear or see-through and enable a person to be able to see through the cap to see the positions of the posts 254a and 254b in the interior of the sprinkler head structure and thereby determine the boundaries of the spray pattern. The alternative cap thereby enables a user to see and also set the boundaries of a spray pattern without having to remove the cap from the head.

In another alternative embodiment, the cap includes only one ring which is adjustable using the same key 256 described above. The ring includes a post similar to the posts 254a or 254b described above, which extends downwardly from the bottom surface of the ring and into the interior of the head. A user uses the key 256 to engage the slots in the top surface of the ring and rotates the ring to position the post to set the second boundary or non-fixed boundary of the spray pattern. The fixed boundary and the boundary set by the user establish the boundaries for the desired spray pattern.

The cap in this embodiment or other embodiments is also clear and enables the user to see through the cap to determine and/or adjust the position of the post to adjust the spray pattern without having to remove the cap.

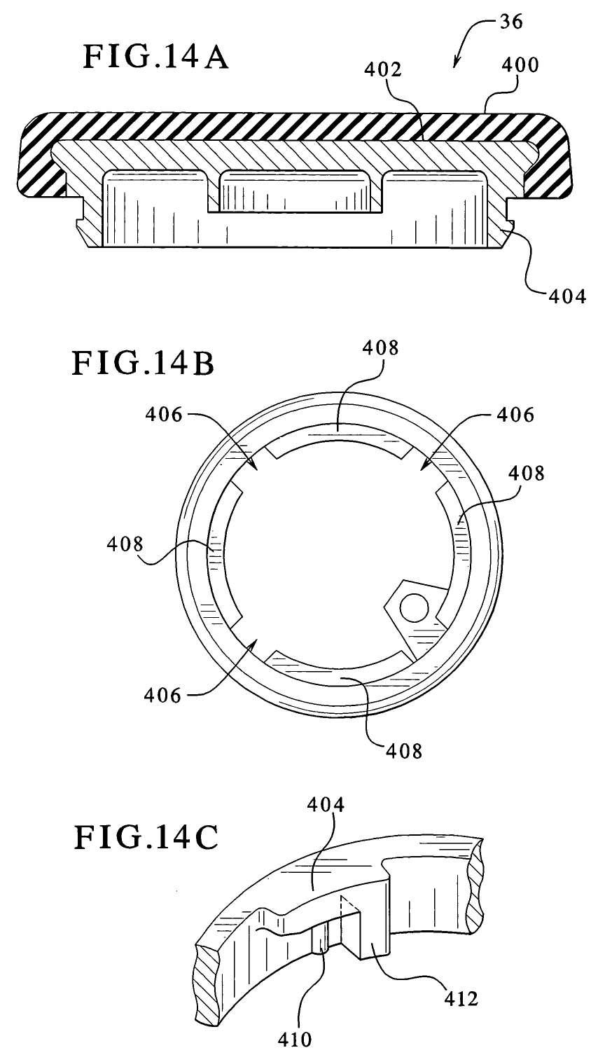

Referring now to attached FIGS. 14A, 14B and 14C, the cap 36 includes an outer portion 400 and an inner portion 402 which has a bayonet style configuration. Specifically, the bayonet style configuration of the inner portion 402 includes extensions 404 which positioned and inserted into the spaces 406 between the threaded sections 408 included on the top inside surface of the head. To close and lock the cap onto the head, a user places the cap 36 onto the head 20 so that the extensions 404 fit into the spaces 406 between the spaced apart threaded sections 408. The user then twists or turns the cap 36 to engage the extensions 404 with the threaded sections 408 of the head. The user turns the cap one-eighth of a turn until one of the extensions 404 contact and frictionally engage a bump or protrusion 410 formed on one of the threaded sections 408. The extension is turned or rotated past the bump 410 and clicks into place between the bump 410 and the stopping member 412 to lock the cap in place. The cap can further be secured in place by inserting and securing a screw or other suitable attachment member through the cap and into the head.

The cap 36 is unlocked and removed from the sprinkler head structure by reversing the rotation of the cap until the extensions 404 are positioned in the spaces or openings 406. The cap can then be lifted upwardly and away from the head. In this embodiment, the cap 36 is easy to insert and remove from the top of the head, resists unintentional removal such as when the cap pops off of the gear drive when the water lines are flushed with air and is vandal resistant because of the twist and lock feature of the bayonet style configuration.

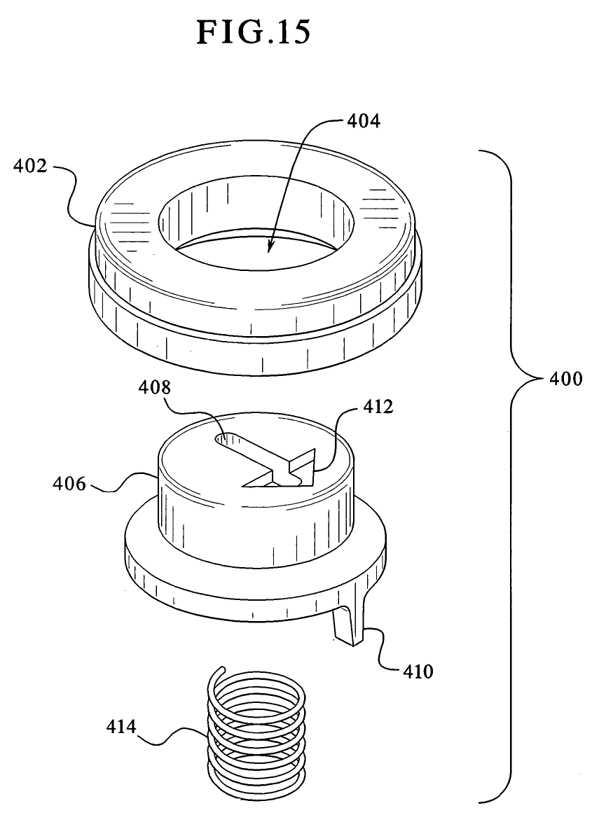

Referring now to FIG. 15, an alternative embodiment of the cap 400 is illustrated where the alternative cap 400 includes a outer member 402 defining an opening 404 adapted to receive an inner member or adjustment section 406. The adjustment section 406 is movably mounted within the outer member 402 and is biased upwardly by a suitable resilient member such as a spring 414. The adjustment section 406 includes an adjustment arm 410 connected to and downwardly extending from the bottom of the adjustment section. In one embodiment, the arm 410 is integrally formed with the adjustment section 406 and is adapted to engage a corresponding slot or groove defined by the adjustment member of the click set. The adjustment section 406 defines a slot or groove 408 adapted to receive a tool (not shown) such as a screwdriver. The spring 414 biases the adjustment section 406 upwardly so that the adjustment section is flush with the outer member 402 of the cap. To change the position of the adjustment member of the click set, a user inserts the tool into the slot 408 and presses downwardly on the adjustment section 406 and the spring 414. The user rotates the adjustment section 406 until the arm 410 engages the slot on the adjustment member of the click set. The user rotates the adjustment member until the adjustment member is aligned with the desired boundary of the spray pattern. When the adjustment member is in the desired position, the tool is removed from the slot 408 and the adjustment section 406 moves upwardly back into position within the outer member 402 of the cap. In one embodiment, the slot 408 includes an arrow 412 or other indicator formed on the surface of the adjustment section 406 to indicate the relative position of the adjustment member and the boundary of the spray pattern.

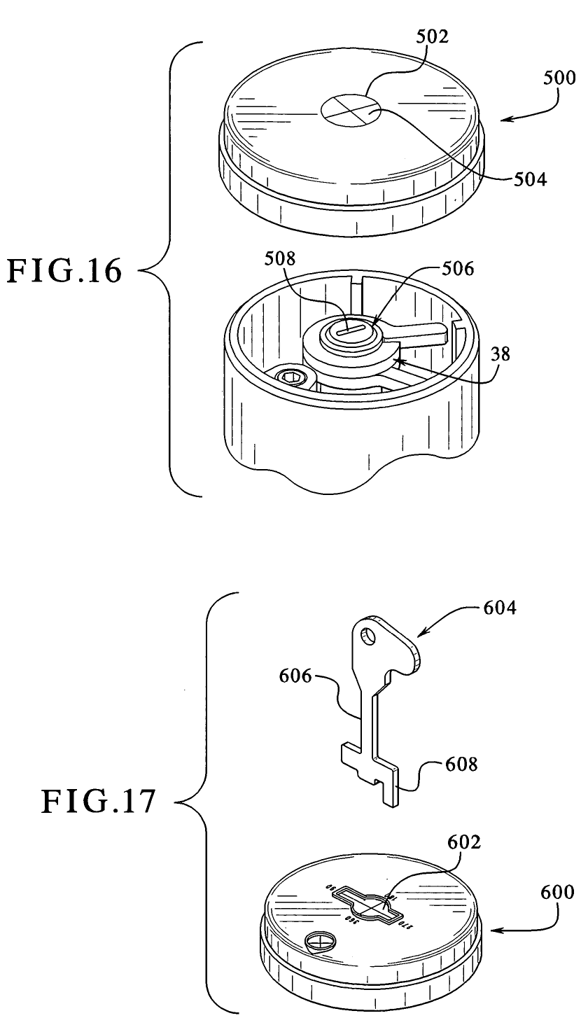

Referring now to FIG. 16, another alternative embodiment of the cap is illustrated where the alternative cap 500 defines an opening 502 covered by flaps 504 which are integrally formed with the cap and extend generally over the opening to cover the opening and prevent sand, dirt or other particles from entering the head through the opening. The click set 38 includes an adjustment member 506 that is connected to the click set and more specifically, connected to one of the adjustment members of the click set. The adjustment member 506 defines a slot or groove adapted to receive an adjustment tool such as a screwdriver for changing the position of the first adjustment member of the click set. In operation, a user inserts the tool through the opening 502 of the cap 500 and into engagement with the slot 508 of the adjustment member 506. The user then rotates the tool to change the position of the adjustment member of the click set to set one of the boundaries of a desired spray pattern. When the adjustment member of the click set is aligned with the desired boundary of the spray pattern, the user removes the tool from the cap 500.

Referring now to FIG. 17, another alternative embodiment is illustrated where the cap 600 defines an opening 602 adapted to receive an adjustment tool 604. The adjustment tool 604 includes a body 606. The body includes an arm 608 which is integrally formed with the body and is adapted to engage a corresponding slot defined by the click set (not shown). A first boundary of a desired spray pattern is fixed and is set by rotating the entire adjustable sprinkler about the threads on the water pipe. The adjustment tool 604 is inserted into the opening 602 to engage the arm 608 with the click set and specifically, with one of the adjustment members of the click set. The tool 604 is turned or rotated to turn or rotate the adjustment member of the click set to set one of the boundaries of the spray pattern. When the boundary is set, the tool 604 is removed from the cap 600.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An adjustable sprinkler connectable to a pressurized water source, said adjustable sprinkler comprising:
an outer housing including inlet means for receiving the pressurized water;
an inner housing positioned within said outer housing and including a body and a head rotatably connected to the body, said head including outlet means for emitting the pressurized water received by said inlet means;
setting means for setting the boundaries of a spray pattern, said setting means positioned inside said inner housing;
cover means for covering a top of said inner housing, said cover means defining an opening adapted to receive an adjuster for adjusting said setting means to change at least one of the boundaries of said spray pattern;
rotating means for generating rotational movement to rotate the head about an axis in one direction and in an opposite direction between the boundaries of said spray pattern;
coupling means for coupling the rotating means to said head; and
resisting means for providing resistance to said coupling means, said resisting means being in frictional engagement with said coupling means, wherein said resisting means enables the coupling means to rotate with said rotating means during normal operation and rotate independently from said rotating means if the head is manually rotated.

2. The adjustable sprinkler of claim 1, which includes filtering means for filtering particles from said pressurized water positioned adjacent to said inlet means.

3. The adjustable sprinkler of claim 1, wherein said outlet means includes a removable nozzle selected from a plurality of different removable nozzles.

4. The adjustable sprinkler of claim 1, wherein said setting means includes a first boundary adjustment means for setting the first boundary of the spray pattern and a second boundary adjustment means for setting the second boundary of the spray pattern.

5. The adjustable sprinkler of claim 4, wherein at least one of said first boundary adjustment means and said second boundary adjustment means includes control means for controlling the movement of said first and second boundary adjustment means, said control means adapted to receive said adjuster.

6. The adjustable sprinkler of claim 1, wherein said cover means includes sealing means for sealing the opening.

7. The adjustable sprinkler of claim 1, which includes reducing means for reducing the rate of the rotational movement generated by said rotating means, said reducing means being coupled to said rotating means.

8. An adjustable sprinkler connectable to a pressurized water source, said adjustable sprinkler comprising:
an outer housing defining a water inlet;
an inner housing mounted in said outer housing, said inner housing including a body and a head rotatably connected to the body, said body being slideably connected to said outer housing;
a water outlet connected to said head;
a driver mounted in said head, said driver rotatable in one direction and in an opposite direction at a designated rate of rotation;
a reverser positioned adjacent to said driver, said reverser operable to change the direction of said driver;
a spray pattern controller coupled to the reverser, said spray pattern controller being adjustable to set a spray pattern having a first boundary and a second boundary, said spray pattern controller adapted to receive an adjuster controllable for adjusting at least one of said first and second boundaries of said spray pattern;
at least one resistor connected to an inside surface of said body; and
a reducer connected between said driver and a rotary output member, said reducer operable to rotate said rotary output member in the same direction as said driver and at a rate of rotation less than said rate of rotation of said driver, wherein said reducer is in frictional engagement with said resistor of said body to enable said reducer to rotate the head in unison with the rotation of said rotary output member and independently rotate the head separate from the rotation of the rotary output member if said head is manually rotated.

9. The adjustable sprinkler of claim 8, which includes a screen mounted adjacent to the inlet.

10. The adjustable sprinkler of claim 9, wherein said reverser includes:
a retainer including a base, at least two fluid channels defined in said base, at least two fluid inlets connected to an end of said fluid channels and extending above said base and a pair of oppositely positioned support walls connected to and extending upwardly from said base, wherein each of said walls defines a plurality of slots;
a mounting member fixedly connected to said retainer, said mounting member including a hub and a pair of oppositely and diametrically positioned upwardly extending posts, each of said posts including a first and second surface;
an oscillator including a slot and two pairs of oppositely positioned fluid directing surfaces, each of said pairs of fluid directing surfaces adapted to direct the water received from the inlet against the impeller to cause the impeller to rotate, wherein the water directed from one of said pairs of fluid directing surfaces causes the impeller to rotate in one direction and the other of said pairs of fluid directing surfaces causes the impeller to rotate in an opposite direction; and
a lever positioned in said slot and adapted to pivot in said slot, said lever including first and second outwardly extending arms, each of said arms including a first and second surface, wherein when the lever pivots and causes the first surfaces of said arms to engage said first surfaces of the posts, the oscillator causes one of said pairs of fluid directing surfaces to direct water against the impeller, and when the lever pivots and causes the second surfaces of said arms to engage said second surfaces of the posts, the oscillator causes the other of said pairs of fluid directing surfaces to direct water against the impeller.

11. The adjustable sprinkler of claim 8, wherein the reducer includes a gear housing having a plurality of planetary gears sequentially positioned and matingly engaged inside said gear housing.

12. The adjustable sprinkler of claim 11, wherein the gear housing includes a first section having a first diameter and a second section including a second diameter, wherein said second diameter is greater than said first diameter and wherein, said second section is frictionally engaged with said resistor.

13. The adjustable sprinkler of claim 11, wherein the reducer includes a cover adapted to sealingly engage the bottom of the gear housing.

14. The adjustable sprinkler of claim 8, which includes a cap removably mounted to said head, said cap defining an adjustment opening for receiving said adjuster.

15. The adjustable sprinkler of claim 14, wherein said cap includes a top member and a bottom member, said bottom member fixedly mounted to said head, said top member adapted to be connected to said bottom member, wherein the connection of said top and bottom members defines said adjustment opening.

16. The adjustable sprinkler of claim 15, wherein the top member of the cap includes a top surface having a plurality of indicators which indicate different spray patterns.

17. The adjustable sprinkler of claim 8, wherein the spray pattern controller includes a first adjustment member fixable to set the first boundary of said spray pattern and a second adjustment member adjustable to set the second boundary of said spray pattern.

18. The adjustable sprinkler of claim 17, wherein the second adjustment member defines a slot which is adapted to matingly engage an end of said adjuster.

19. The adjustable sprinkler of claim 8, wherein the resistor includes a longitudinal fin integrally formed on the inside surface of said body.

20. An adjustable sprinkler connectable to a pressurized water source, said adjustable sprinkler comprising:
an outer housing defining a water inlet;
an inner housing slideably connected to said outer housing, said inner housing including a body and a head rotatably connected to the body;
a nozzle connected to said head;
a driver mounted in said body, said driver rotatable in one direction and in an opposite direction;
a rotary output member rotatably connected to said driver and adapted to rotate in the same direction as the driver and at a rate of rotation that is less than the rate of rotation of said driver; and
a spray pattern controller mounted in said head, said spray pattern controller including a click set having a first adjustment member and a second adjustment member, said first adjustment member fixable to indicate a first boundary of a designated spray pattern and said second adjustment member movable to indicate a second boundary of the designated spray pattern; and
a cap adapted to sealingly engage the top of the head, said cap defining at least one adjustment opening which is adapted to receive an adjuster, said adjuster being controllable to adjust said second adjustment member.

21. The adjustable sprinkler of claim 20, wherein said cap includes a top member and a bottom member, said bottom member fixedly mounted to said head, said top member connected to said bottom member, wherein the connection of said top and bottom members defines said adjustment opening.

22. The adjustable sprinkler of claim 21, wherein the top member of the cap includes a top surface having a plurality of indicators which indicate different spray patterns.

23. The adjustable sprinkler of claim 20, wherein the head includes a nozzle retainer positioned adjacent to the nozzle and adapted to hold the nozzle in place.

24. The adjustable sprinkler of claim 23, wherein the nozzle retainer includes a screw threadingly engaged with said head, wherein said screw is rotatable to position at least a portion of the screw in the water stream emitted by the nozzle to deflect the water stream.

25. The adjustable sprinkler of claim 20, wherein said cap defines a second adjustment opening positioned adjacent to said screw, said second adjustment opening adapted to receive a different end of said adjuster and enable said adjuster to engage the screw.

26. The adjustable sprinkler of claim 20, wherein said second adjustment member of said click set defines a slot adapted to be engaged by the adjuster.

27. An adjuster for adjusting a spray pattern for an adjustable sprinkler, wherein the adjustable sprinkler includes a head rotatably mounted to a body, a spray pattern controller mounted in the head and a nozzle retainer movably mounted in the head, wherein the spray pattern controller includes a first adjustment member and a second adjustment member, the first adjustment member fixable at assembly to indicate a first boundary of the spray pattern, the second adjustment member movable to indicate a second boundary of the spray pattern, said adjuster comprising:
an elongated body having a first end and a second end, said first end including a hub and at least one arm extending from said hub, said hub adapted to engage the spray pattern controller to hold the controller in place, said arm adapted to engage the second adjustment member to control the movement of said second adjustment member, said second end adapted to engage the nozzle retainer; and
a handle attached to said body.

28. The adjuster of claim 27, wherein the handle includes a finger grip.

29. The adjuster of claim 27, wherein the handle includes a plurality of finger grips.

30. An adjustable sprinkler connectable to a pressurized water source, said adjustable sprinkler comprising:
an outer housing defining a water inlet;
an inner housing mounted in said outer housing, said inner housing including a body and a head rotatably connected to the body, said body being slideably connected to said outer housing;
a water outlet connected to said head;
a driver mounted in said head, said driver rotatable in one direction and in an opposite direction at a designated rate of rotation;
a reverser positioned adjacent to said driver, said reverser operable to change the direction of said driver;
a coupling member centrally positioned in said head and said body, said coupling member coupled between said head and said reverser;
a spray pattern controller engageble with said coupling member to set the first and second boundaries of a spray pattern, said spray pattern controller having a non-engaging position and an engaging position relative to the coupling member, said non-engaging position adapted to cause the head to rotate in a continuous circular spray pattern, and said engaging position adapted to enable the spray pattern controller to receive an adjuster controllable for adjusting at least one of said first and second boundaries to set a part circle spray pattern; and
a cap adapted to sealingly engage the top of the head, said cap defining at least one adjustment opening which is adapted to receive the adjuster, wherein said adjuster is inserted into the cap to cause said adjuster being controllable to adjust at least one of the first and second boundaries of said spray pattern.

31. The adjustable sprinkler of claim 30, which includes a screen mounted adjacent to the inlet.

32. The adjustable sprinkler of claim 30, wherein said reverser includes:
a retainer including a base, at least two fluid channels defined in said base, at least two fluid inlets connected to an end of said fluid channels and extending above said base and a pair of oppositely positioned support walls connected to and extending upwardly from said base, wherein each of said walls defines a plurality of slots;
a mounting member fixedly connected to said retainer, said mounting member including a hub and a pair of oppositely and diametrically positioned upwardly extending posts, each of said posts including a first and second surface;
an oscillator including a slot and two pairs of oppositely positioned fluid directing surfaces, each of said pairs of fluid directing surfaces adapted to direct the water received from the inlet against the impeller to cause the impeller to rotate, wherein the water directed from one of said pairs of fluid directing surfaces causes the impeller to rotate in one direction and the other of said pairs of fluid directing surfaces causes the impeller to rotate in an opposite direction; and
a lever positioned in said slot and adapted to pivot in said slot, said lever including first and second outwardly extending arms, each of said arms including a first and second surface, wherein when the lever pivots and causes the first surfaces of said arms to engage said first surfaces of the posts, the oscillator causes one of said pairs of fluid directing surfaces to direct water against the impeller, and when the lever pivots and causes the second surfaces of said arms to engage said second surfaces of the posts, the oscillator causes the other of said pairs of fluid directing surfaces to direct water against the impeller.

33. The adjustable sprinkler of claim 30, wherein the reducer includes a gear housing having a plurality of planetary gears sequentially positioned and matingly engaged inside said gear housing.

34. The adjustable sprinkler of claim 33, wherein the gear housing includes a first section having a first diameter and a second section including a second diameter, wherein said second diameter is greater than said first diameter and wherein, said second section is adapted to frictionally engage at least one resistor connected to an inside surface of said body.

35. The adjustable sprinkler of claim 33, wherein the reducer includes a cover adapted to sealingly engage the bottom of the gear housing.

36. The adjustable sprinkler of claim 30, which includes a cap removably mounted to said head, said cap defining an adjustment opening for receiving said adjuster.

37. The adjustable sprinkler of claim 36, wherein said cap includes a top member and a bottom member, said bottom member fixedly mounted to said head, said top member adapted to be connected to said bottom member, wherein the connection of said top and bottom members defines said adjustment opening.

38. The adjustable sprinkler of claim 37, wherein the top member of the cap includes a top surface having a plurality of indicators which indicate different spray patterns.

39. The adjustable sprinkler of claim 30, wherein the spray pattern controller includes a first adjustment member fixable to set the first boundary of said spray pattern and a second adjustment member adjustable to set the second boundary of said spray pattern.

40. The adjustable sprinkler of claim 39, wherein the second adjustment member defines a slot which is adapted to matingly engage an end of said adjuster.
